(19) United States
(12) Patent Application Publication
(10) Pub. No.: US 2016/0004455 A1
(43) Pub. Date: Jan. 7, 2016

(54) METHOD OF CONTROLLING SPLITTING OF DATA, AND SYSTEM

(71) Applicant: FUJITSU LIMITED, Kawasaki-shi (JP)

(72) Inventor: Kazunori IWASA, Yokohama (JP)

(73) Assignee: Fujitsu Limited, Kawasaki-shi (JP)

(21) Appl. No.: 14/749,031

(22) Filed: Jun. 24, 2015

(30) Foreign Application Priority Data
Jul. 4, 2014 (JP) 2014-138314

(51) Int. Cl. G06F 3/06

(52) U.S. Cl. CPC G06F 3/0608; G06F 3/0685; G06F 3/0665

(57) ABSTRACT

A method includes: obtaining access states of a plurality of data when accessing to a first target data of the plurality of data is executed, respective data of the plurality of data being split into a certain data and other data, the certain data being stored in a first storage apparatus and the other data being stored in a second storage apparatus; calculating a splitting ratio for the first target data based on the access states and an available capacity of the first storage apparatus; splitting the first target data into a first piece of data and a second piece of data in accordance with the calculated splitting ratio; storing the first piece of data in the first storage apparatus; and storing the second piece of data in the second storage apparatus.

### CROSS-REFERENCE TO RELATED APPLICATION

This application is based upon and claims the benefit of priority of the prior Japanese Patent Application No. 2014-138314, filed on Jul. 4, 2014, the entire contents of which are incorporated herein by reference.

### FIELD

The embodiments discussed herein are related to a technology for controlling splitting of data and a system.

### BACKGROUND

The amounts of data in computer systems are on an increasing trend. Data used by computers are stored in internal storage devices of the computer systems. A technology for storing data, used by computers, in external storage devices of computer systems has been known in order to store increasing amounts of data.

As measures against leakage of data from those storage devices, there is a technology in which data is split and stored in a plurality of storage devices to enhance the data confidentiality.

An example of related art is Japanese Laid-open Patent Publication No. 2008-97591.

### SUMMARY

According to an aspect of the invention, a method includes: obtaining access states of a plurality of data when accessing to a first target data of the plurality of data is executed, respective data of the plurality of data being split into a certain data and other data, the certain data being stored in a first storage apparatus and the other data being stored in a second storage apparatus; calculating a splitting ratio for the first target data based on the access states and an available capacity of the first storage apparatus; splitting the first target data into a first piece of data and a second piece of data in accordance with the calculated splitting ratio; storing the first piece of data in the first storage apparatus; and storing the second piece of data in the second storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example configuration of an information processing system in the present embodiment;

FIG. 2 illustrates a hardware configuration of a unified storage server illustrated in FIG. 1;

FIG. 3 is a diagram illustrating the configuration of software modules in the unified storage server in the present embodiment;

FIG. 4 illustrates one example of update history illustrated in FIG. 3;

FIG. 5 illustrates an example of access-ranking information illustrated in FIG. 3;

FIG. 6 is a diagram illustrating an overview of data splitting processing;

FIG. 7 is a diagram illustrating processing, performed by the unified storage server in the present embodiment, for calculating a splitting ratio for data;

FIGS. 8A and 8B are diagrams illustrating a first example for describing the states of a local storage area when the splitting ratio is fixed and when the splitting ratio is calculated for each piece of data;

FIGS. 9A and 9B are diagrams illustrating a second example for describing the states of the local storage area when the splitting ratio is fixed and when the splitting ratio is calculated for each piece of data;

FIGS. 10A and 10B are diagrams illustrating a third example for describing the states of the local storage area when the splitting ratio is fixed and when the splitting ratio is calculated for each piece of data;

FIG. 11 is a first flowchart for describing data update processing performed by an encrypting and splitting module (FIG. 3) in the unified storage server in the present embodiment;

FIG. 12 is a second flowchart illustrating the data update processing performed by the encrypting and splitting module;

FIG. 13 is a first flowchart illustrating processing for calculating a splitting ratio for data to be updated;

FIG. 14 is a second flowchart illustrating processing for calculating the splitting ratio for the data to be updated;

FIG. 15 is a flowchart illustrating update processing on data IDs other than the ID of data to be updated;

FIG. 16 is a first flowchart illustrating data referring processing performed by the encrypting and splitting module;

FIG. 17 is a second flowchart illustrating the data referring processing performed by the encrypting and splitting module;

FIG. 18 is a table illustrating, in a specific example, the time of access to a storage and an upper-limit value and a lower-limit value of the splitting ratio;

FIG. 19 is a table illustrating, in a specific example, information about the local storage area and the size of data;

FIG. 20 illustrates access-ranking information when the update processing is performed on data “Data5”;

FIG. 21 is a table illustrating information about the local storage and the size of data after the update processing is performed on the data “Data5”;

FIG. 22 is a table illustrating the time of access to the data “Data5”;

FIG. 23 is a table illustrating the average usage efficiencies of the local storage area when the splitting ratio is fixed and when the splitting ratio is calculated for each piece of data; and

FIG. 24 is a table illustrating the average access times when the splitting ratio is fixed and the splitting ratio is calculated for each piece of data.

### DESCRIPTION OF EMBODIMENTS

When data is split and the resulting data are stored in a storage device inside a computer system and a storage device outside the computer system, the data splitting is performed with a predetermined splitting ratio. In general, the storage device inside the computer system has higher data access performance (i.e., the writing/reading speed is high).

However, since the size of data and the capacity of the external storage device vary, there are cases in which it is difficult to set an appropriate splitting ratio.

In one aspect, the present embodiment improves the access speed, while maintaining data confidentiality.

An embodiment will be described below with reference to the accompanying drawings. It is to be noted, however, that the technical scope of the present disclosure is not limited to the embodiment and also includes what are recited in the claims and equivalents thereof.

[Information Processing System]

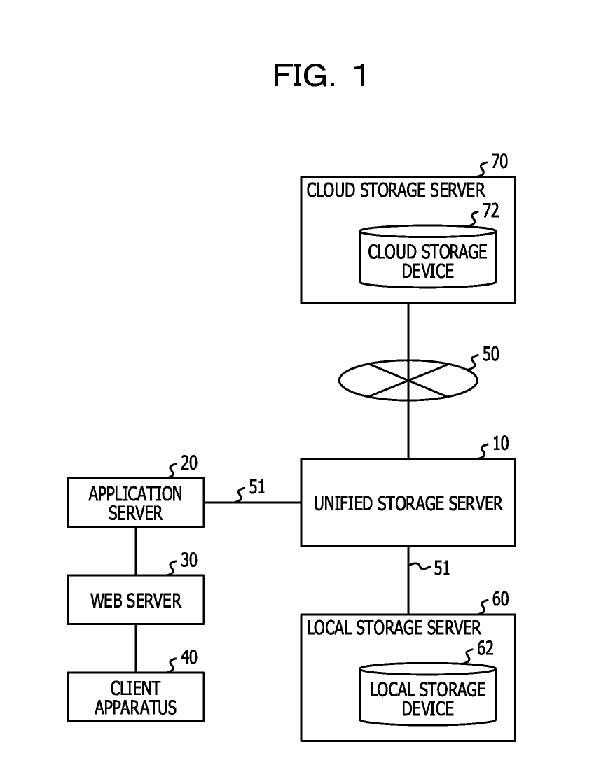

FIG. 1 illustrates an example configuration of an information processing system in the present embodiment. The information processing system illustrated in FIG. 1 includes a client apparatus 40, an application server 20, a web server 30, a unified storage server 10, a cloud storage server 70, and a local storage server 60. In the example illustrated in FIG. 1, the client apparatus 40 is, for example, a personal computer or a portable terminal. Although a case in which the number of client apparatuses 40 is one is described in this example, a plurality of client apparatuses 40 may connect to the web server 30.

The unified storage server (a data-splitting control apparatus) 10 illustrated in FIG. 1 connects to the cloud storage server (a second storage apparatus) 70 through a public area network (an Internet) 50. The unified storage server 10 illustrated in FIG. 1 connects to the local storage server (a first storage apparatus) 60 through a local area network 51. The cloud storage server 70 has a cloud storage device 72, and the local storage server 60 has a local storage device 62. The client apparatus 40 and the web server 30 connect to each other through an Internet 52 in a local area.

Although, in the example illustrated in FIG. 1, the cloud storage server 70 has one cloud storage device 72, the present disclosure is not limited to this example. The cloud storage server 70 may have a plurality of cloud storage devices 72. Similarly, the local storage server 60 may also have a plurality of local storage devices 62.

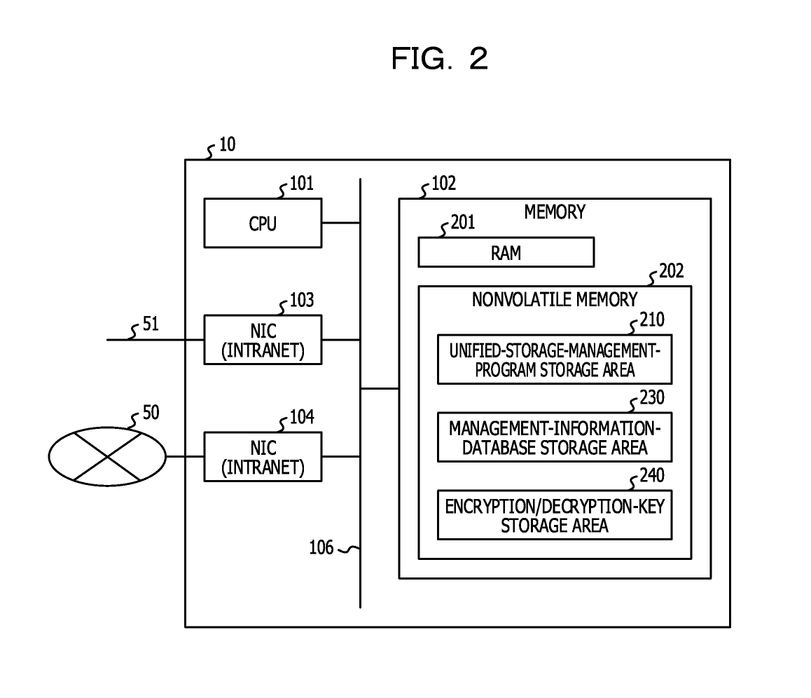

The application server 20, the web server 30, the cloud storage server 70, and the local storage server 60 have hardware configurations including central processing units (CPUs), memories, and so on. The hardware configuration of the unified storage server 10 is described later with reference to FIG. 2.

The application server 20, the web server 30, and the unified storage server 10 illustrated in FIG. 1 operate in cooperation with each other. The web server 30 receives a service request, based on the Hypertext Transfer Protocol (HTTP), from the client apparatus 40 and performs, for example, user authentication processing. When the user authentication succeeds, the web server 30 issues a notification indicating the service request to the application server 20.

In response to the service request from the web server 30, the application server 20 performs predetermined processing using an application. In accordance with a result of the processing, the application server 20 outputs a data access request to the unified storage server 10. Examples of the data access request include a request for updating data managed by the unified storage server 10, a request for referring to the data, a request for deleting the data, and a request for processing for writing new data. That is, the unified storage server 10 corresponds to a database server.

The cloud storage server 70 authenticates the access request received through the public area network 50 and performs access processing on the cloud storage device 72. The local storage server 60 also authenticates the access request received through the local area network 51 and performs access processing on the local storage device 62.

In accordance with a secret splitting scheme, the unified storage server 10 stores data to be managed in the cloud storage device 72 in the cloud storage server 70 and the local storage device 62 in the local storage server 60 in a distributed manner. In the secret splitting scheme, encrypted data is split into a plurality of pieces of distribution information. As a result, restoration of the data involves a predetermined number of pieces of distribution information of the split pieces of information. In the example illustrated in FIG. 1, data is not decryptable using only either the data stored in the cloud storage device 72 or the data stored in the local storage device 62. Thus, it is possible to realize data confidentiality and restorability.

For example, when a data update request is received from the application server 20, the data stored in the cloud storage device 72 in the cloud storage server 70 and the data stored in the local storage device 62 in the local storage server 60 are both updated. The unified storage server 10 updates the data, stored in the cloud storage device 72, through the public area network 50 and also updates the data, stored in the local storage device 62, through the local area network 51.

Similarly, for example, upon receiving a data referring request from the application server 20, the unified storage server 10 reads the data stored in the cloud storage device 72 in the cloud storage server 70 and the data stored in the local storage device 62 in the local storage server 60. The unified storage server 10 then combines the read data and outputs the resulting data to the application server 20. When a new data writing request and a data deletion request are received, similar processing is performed.

As described above, the unified storage server 10 accesses the cloud storage server 70 through the public area network (Internet) 50. Also, the unified storage server 10 accesses the local storage server 60 through the local area network 51. Thus, the unified storage server 10 can access the local storage device 62 at higher speed than the cloud storage device 72.

[Hardware Configuration of Unified Storage Server]

FIG. 2 illustrates a hardware configuration of the unified storage server 10 illustrated in FIG. 1. The unified storage server 10 illustrated in FIG. 2 has, for example, a central processing unit (CPU) 101 and a memory 102. The unified storage server 10 further has a network interface card (NIC) 103 for a local area network and a NIC 104 for a public area network. The CPU 101, the memory 102, and NICs 103 and 104 are connected to each other through a bus 106. The memory 102 also has a random access memory (RAM) 201, a nonvolatile memory 202, and so on.

The CPU 101 connects to the memory 102 and so on through the bus 106 and also performs overall control of the unified storage server 10. The NIC 104 for the local area network controls communication with an information processing apparatus, such as the application server 20 illustrated in FIG. 1, through the local area network 51. The NIC 105 for the public area network controls communication with an information processing apparatus, such as the cloud storage server 70 illustrated in FIG. 1, through the public area network (the Internet in an external environment) 50.

The RAM 201 in the memory 102 stores data and so on on which the CPU 101 performs processing. The nonvolatile memory 202 in the memory 102 has an area (not illustrated) in which an operating system (OS) and a program to be executed by the CPU 101 are stored and an area 210 in which a unified-storage management program in the present embodiment is stored. The nonvolatile memory 202 further has an area 230 in which a management information database is stored and an area 240 in which encryption/decryption keys are stored. The nonvolatile memory 202 is constituted by a hard disk drive (HDD), a nonvolatile semiconductor memory, and so on.

The CPU 101 executes the unified-storage management program (hereinafter referred to as a “unified-storage management program 210”) in the unified-storage management program storage area 210 to thereby execute the unified-storage management processing in the present embodiment. The “unified-storage management processing” refers to processing for unifying and managing both the data stored in the cloud storage device 72 (FIG. 1) and the data stored in the local storage device 62 (FIG. 1) and controlling access to the stored data.

The management information database (hereinafter referred to as the “management information database 230”) in the management information database storage area 230 has information that is referred to by the unified-storage management program 210. The encryption/decryption keys (hereinafter referred to as “encryption/decryption keys 240”) in the encryption/decryption key storage area 240 are keys with which, in accordance with the secret splitting scheme, the unified-storage management program 210 encrypts or decrypts data to be accessed.

[Configuration of Software Modules in Unified Storage Server]

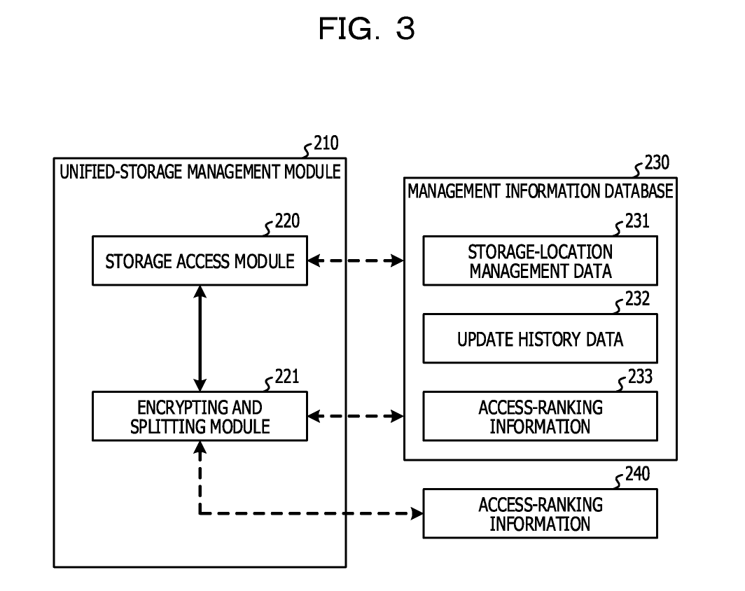

FIG. 3 is a diagram illustrating the configuration of software modules in the unified storage server 10 illustrated in FIG. 1. The unified-storage management program 210 (FIG. 2) has a storage access module 220 and an encrypting and splitting module 221.

The management information database 230 (FIG. 2) stores therein storage-location management data 231, update history data 232, and access-ranking information 233. The storage-location management data 231 has, for example, information of addresses at which data to be managed, the addresses being located in the local storage server 60 and the cloud storage server 70, are stored.

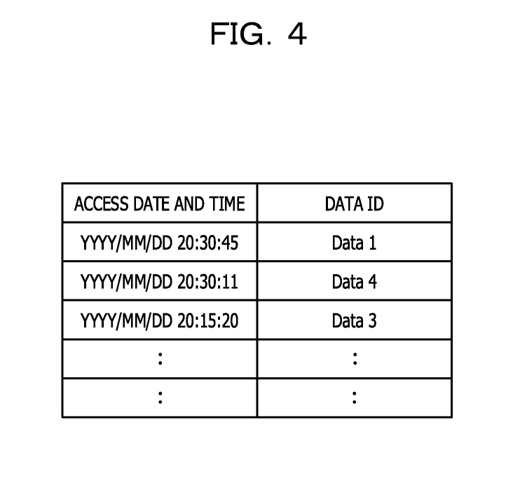

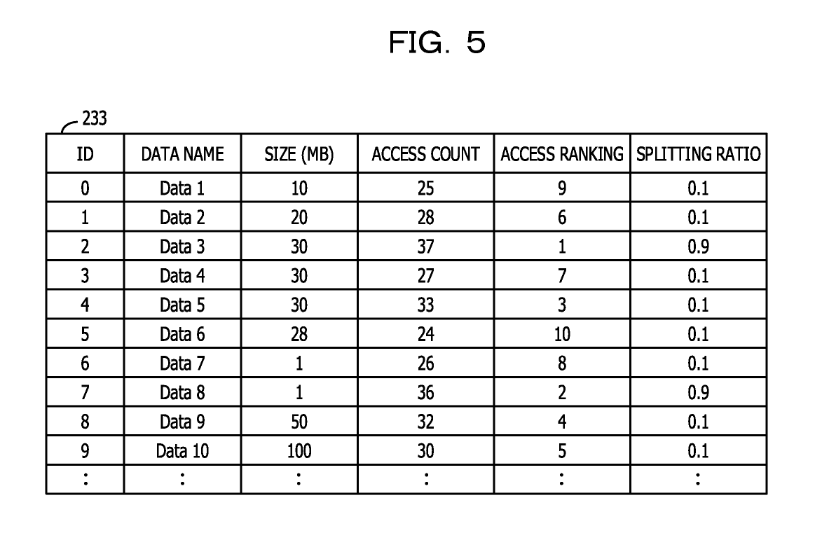

The update history data 232 is also history information of update processing that has been performed. Details of the update history data 232 are described later with reference to FIG. 4. The access-ranking information 233 is also information having an access ranking based on the number of references and the number of updates with respect to each piece of data. Details of the access-ranking information 233 are described below with reference to FIG. 5.

In response to a data access request from the application server 20, the storage access module 220 refers to the storage-location management data 231 to obtain the information of addresses at which data to be accessed is stored. The storage access module 220 then notifies the encrypting and splitting module 221 of the obtained address information.

Based on the address information of the addresses at which the data to be accessed is stored, the encrypting and splitting module 221 performs processing for accessing the data. For example, when the access request is a data update request, the encrypting and splitting module 221 uses the encryption key of the encryption/decryption keys 240 to perform processing for encrypting data to be updated. The encrypting and splitting module 221 also refers to the access-ranking information 233, the update history data 232, and so on to calculate a splitting ratio for the data to be updated. The splitting ratio is a ratio of the size of data stored in the local storage device 62 to the total size of data.

The encrypting and splitting module 221 splits encrypted data, based on the splitting ratio. The storage access module 220 stores the data, split according to the splitting ratio, in the cloud storage device 72 and the local storage device 62.

[Update History Data]

FIG. 4 illustrates one example of the update history data 232 illustrated in FIG. 3. As described above, the update history data 232 is history information of update processing. The update history data 232 illustrated in FIG. 4 has information of access date and time when update processing was performed and information of data identification (ID) of data to be updated.

The unified storage server 10 gives the data to be managed a data ID for uniquely identifying the data. The data in the present embodiment is, for example, a table of a relational database. The data in the present embodiment, however, is not limited to this example and may be data other than a table.

The update history data 232 illustrated in FIG. 4 indicates that update processing on a data ID “Data3” was performed at access date and time “YYYY/MM/DD 20:15:20”. Thereafter, the update history data 232 indicates that update processing on a data ID “Data4” was performed at access date and time “YYYY/MM/DD 20:30:11”, and update processing on a data ID “Data1” was performed at access date and time “YYYY/MM/DD 20:30:45”. That is, according to the update history data 232 illustrated in FIG. 4, update processing was performed in the order “Data3”, “Data4”, and “Data1”.

When processing for accessing data is performed, the encrypting and splitting module 221 updates the update history data 232. Although the update history data 232 is illustrated in the example in FIG. 4, the unified storage server 10 may further have reference history data.

[Access-Ranking Information]

FIG. 5 illustrates an example of the access-ranking information 233 illustrated in FIG. 3. The access-ranking information 233 in FIG. 5 has information for respective pieces of data already stored in the local storage server 60 and the cloud storage server 70. The access-ranking information 233 has, for the respective pieces of data, information of data IDs (identification), data names, data sizes, access counts, access rankings, and splitting ratios.

The data IDs are the same as the data IDs described above with reference to FIG. 4. Each data name is the name of data. The size of data is the size of entire data stored in the cloud storage device 72 and the local storage device 62. The access count is the number of times update processing and referring processing on data have occurred.

The access ranking is a ranking among data, the ranking being calculated based on the access count in a predetermined period of time. In this example, the closer to value “1” the access ranking is, the higher the access frequency is, and the closer to value “10”, the lower the access frequency is.

As described above, the splitting ratio is a ratio of the size of data stored in the local storage device 62 to the total size of data. The splitting ratio in FIG. 5 represents a splitting ratio calculated when data update processing was performed last time.

For example, the size of Data1 with ID=0 is 10 megabytes (MB), and the access count is 25. The access ranking for Data1 is 9, and the splitting ratio is 0.1. That is, the access frequency of Data1 is relatively low. Thus, the splitting ratio is low, 10% of the data “Data1” is stored in the local storage device 62, and 90% of the data “Data1” is stored in the cloud storage device 72.

Similarly, the size of “Data2” with “ID=1” is 20 MB, and the access count is 28. Also, the access ranking for “Data2” is 6, and the splitting ratio is “0.1”. Thus, although the access frequency of “Data2” is higher than that of “Data1”, the splitting ratio for “Data2” is the same as that of “Data1”.

The same also applies to other data (Data3 to Data10). As described above, the access-ranking information 233 has information of pre-splitting sizes, access rankings, and splitting ratios already used, with respect to respective pieces of data stored in the local storage device 62 and the cloud storage device 72.

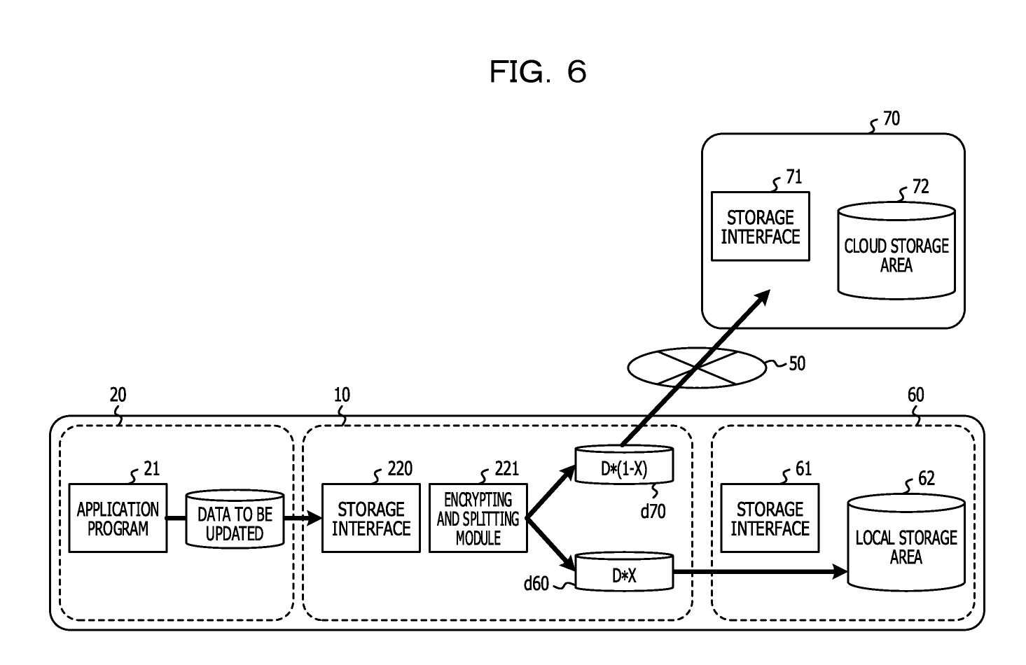

Now, an overview of data splitting processing performed by the unified storage server 10 illustrated in FIGS. 1 to 3 will be described with reference to FIG. 6.

[Overview of Data Splitting Processing]

FIG. 6 is a diagram illustrating an overview of data splitting processing. In FIG. 6, a storage interface in the unified storage server 10 corresponds to the storage access module 220 (hereinafter referred to as a “storage interface 220”) illustrated in FIG. 3.

A storage interface 71 in the cloud storage server 70 (FIG. 1) is a module for controlling access to a cloud storage area. The cloud storage area refers to an area (hereinafter referred to as a “cloud storage area 72”) in the cloud storage device 72 illustrated in FIG. 1. The storage interface 61 in the local storage server 60 (FIG. 1) is a module for controlling access to a local storage area. The local storage area refers to an area (hereinafter referred to as a “local storage area 62”) in the local storage device 62 illustrated in FIG. 1.

An application program 21 that runs on the application server 20 (FIG. 1) in FIG. 6 outputs, for example, data to be updated to the unified storage server 10. The storage interface 220 and the encrypting and splitting module 221 in the unified storage server 10 encrypt input data to be updated and split the encrypted data into data d60 and data d70 in accordance with a splitting ratio X.

The data d60 to be stored in the local storage area 62 is data having a size “D×X”, which is obtained by multiplying the size of the encrypted data to be updated by the splitting ratio X. The storage interface 220 in the unified storage server 10 causes the data d60 to be stored in the local storage area 62 through the storage interface 61.

The data d70 to be stored in the cloud storage area 72 is data having a size “D×(1−X)”, which is obtained by multiplying the size of the encrypted data to be updated by “1−splitting ratio X”. The storage interface 220 in the unified storage server 10 causes the data d70 to be stored in the cloud storage area 72 through the storage interface 71.

Thus, the unified storage server 10 according to the present embodiment encrypts data and splits the encrypted data. The unified storage server 10 then stores the split pieces of data in the different storage areas 62 and 72. Since data is not decryptable using data stored in either of the storage areas, it is possible to realize data confidentiality and restorability.

When the splitting ratio X for splitting data is pre-set during design of a system, the amount of data to be stored in the future and the access frequency of data to be stored in the future are to be predicted, and it is not easy to determine an appropriate splitting ratio. Thus, in the design process, a large amount of work hours is involved in order to set an appropriate splitting ratio X for all data.

Also, even if a splitting ratio is set, the size and the access frequency of data may change owing to an unexpected change in operation, a significant change in the usage method, or the like. In such a case, the splitting ratio that was appropriate when the operation was started may become inappropriate in the middle of the operation.

As described above with reference to FIG. 1, the speed of access to the local storage server 60 is higher than the speed of access to the cloud storage server 70. Thus, setting a large value for the splitting ratio X makes it possible to increase the ratio of the size of data stored in the local storage area 62. This makes it possible to significantly increase the data access speed.

However, when the splitting ratio X is increased, the data access speed improves, but the size of data stored in the local storage area 62 increases. Consequently, when a plurality of pieces of data are stored, the data size may reach the limit of the storage capacity of the local storage area 62. That is, the available capacity of the local storage area 62 becomes a bottleneck, which may make it difficult to meet a request for a data access speed.

On the other hand, when the splitting ratio X is reduced, the size of data stored in the cloud storage area 72 increases. In this case, a network band when data is stored in the cloud storage area 72 becomes a bottleneck, which may make it difficult to meet a request for the data access speed.

Accordingly, each time data update processing is performed, the unified storage server 10 in the present embodiment calculates a splitting ratio X for data to be updated, splits encrypted data to be updated, and stores the split pieces of data in the cloud storage area 72 and the local storage area 62. With this arrangement, the unified storage server 10 can calculate an appropriate splitting ratio X for each unit of data to be updated. In a design process, no work hour for setting an appropriate splitting ratio X is involved.

Thus, the unified storage server 10 calculates a splitting ratio X for each piece of data to be updated, based on the available capacity of the local storage area 62 and the access state of data. With this arrangement, the unified storage server 10 can calculate, in the range of the capacity of the local storage area, a larger splitting ratio X for data having a higher access frequency. Accordingly, the unified storage server 10 can improve the data access speed, while efficiently using the capacity of the local storage area 62.

The unified storage server 10 also calculates a splitting ratio X each time data update processing is performed, considering the access state of data. That is, since the splitting ratio X is calculated in conjunction with a change in the access state of data, a splitting ratio X corresponding to the change can be calculated even when the operation changes.

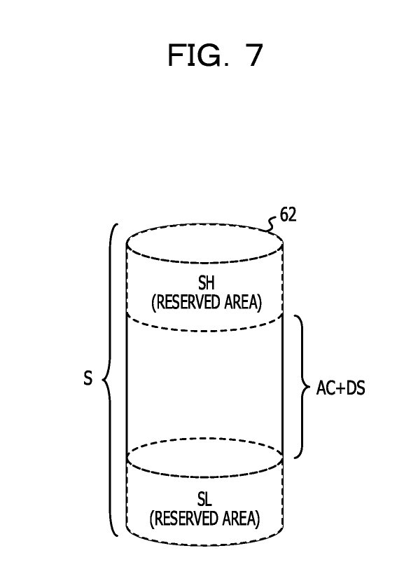

Next, processing for calculating the splitting ratio X will be described with reference to FIG. 7.

[Processing for Calculating Splitting Ratio X]

FIG. 7 is a diagram illustrating an overview of processing, performed by the unified storage server 10 in the present embodiment, for calculating a splitting ratio for data. As described above, the unified storage server 10 in the present embodiment calculates a splitting ratio X for data to be updated, each time the data is updated.

FIG. 7 illustrates the size “S” of an available area of the local storage area 62 and an available capacity “AC” of the local storage area 62 which can be used for data to be updated. The unified storage server 10 calculates a splitting ratio X for data to be updated, in accordance with equation 1 below. That is, as represented by equation 1, the unified storage server 10 calculates a splitting ratio X by dividing the available capacity “AC” of the local storage area 62, the available capacity “AC” being usable for data to be updated, by the size “D” of the data to be updated.

X=AC/Dequation 1

Next, a description will be given of, in equation 1, the available capacity “AC” of the local storage area 62 which can be used for the data to be updated. The unified storage server 10 calculates the available capacity “AC” that can store data to be updated, in accordance with equation 2 below.

AC=S−R+DSequation 2

The value “S” in equation 2 indicates the size of the available area of the local storage area 62 illustrated in FIG. 7. The value “DS” indicates the size of data that corresponds to the data ID of data to be updated and that is already stored in the local storage area 62. As a result of data update processing, data already stored in the local storage area 62 is overwritten. Thus, the unified storage server 10 adds the size “DS” overwritten by the update processing to the available capacity “AC” that can store the data to be updated.

The value “R” indicates the size of a reserved area. The reserved area indicates an area reserved for update of data that is included in the data stored in the local storage area 62 and that is other than data to be updated. In other words, the reserved area indicates the capacity of the local storage area 62 which is used when data other data to be updated is stored during future update in accordance with an appropriate splitting ratio.

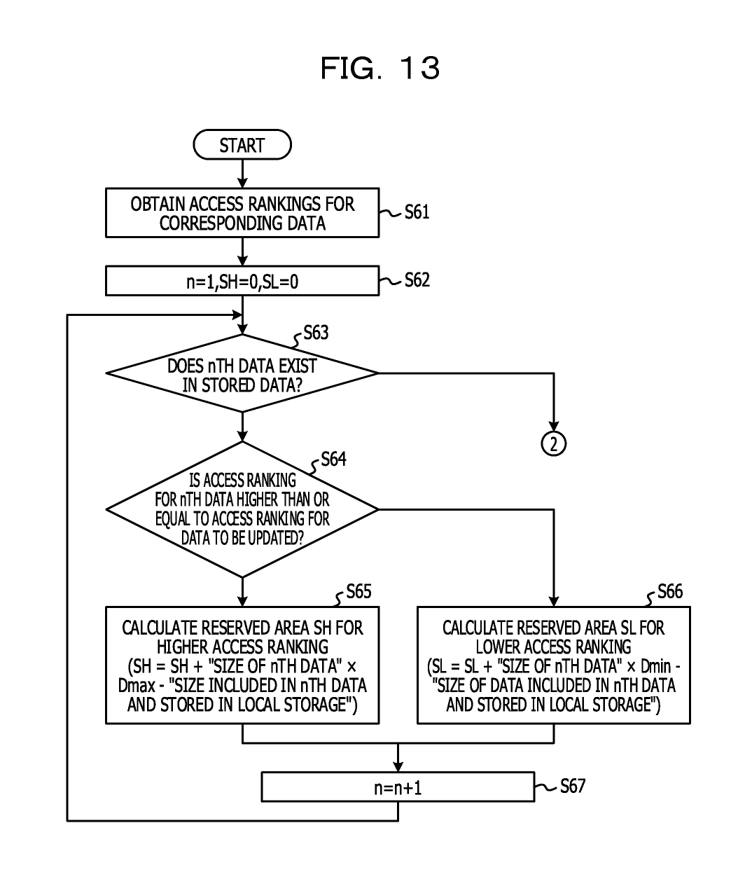

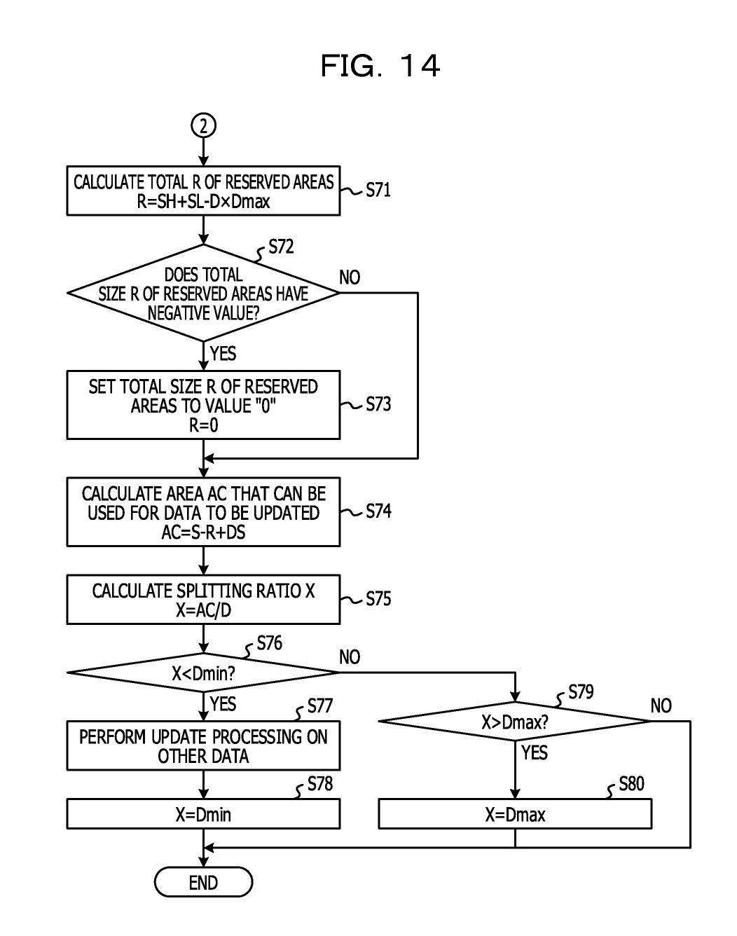

The reserved area is mainly constituted by a size “SH” of a reserved area for data having a high access frequency and a size “SL” of a reserved area for data having a low access frequency, the sizes “SH” and “SL” being illustrated in FIG. 7. The size “SH” represents the capacity of the local storage area 62 which is reserved for update of data having a high access frequency. The size “SL” represents a minimum capacity of the local storage area 62 which is reserved for update of data having a low access frequency. The size “R” of the reserved area is described later with reference to FIGS. 13 and 14.

Referring back to equation 2, the unified storage server 10 subtracts the size “R” of the reserved area reserved for use during future update from the available capacity “S” of the local storage area 62 and adds the size “DS” of data corresponding to the data ID of data to be updated, the data being stored in the local storage area 62. By doing so, the unified storage server 10 calculates the available capacity “AC” of the local storage area 62 which can store the data to be updated.

The unified storage server 10 then calculates a splitting ratio X by dividing the available capacity “AC” of the local storage area 62, the available capacity “AC” being usable for the data to be updated, by the size “D” of the data to be updated.

Thus, the unified storage server 10 calculates a splitting ratio X, considering the available capacity “S” of the local storage and the sizes “R (SH and SL)” of the reserved areas which correspond to the access state of the local storage area 62. That is, the unified storage server 10 calculates a splitting ratio for data to be updated, after reserving the local storage area 62 assumed to be used for each piece of data according to the access state. As a result, the local storage area 62 to be used for future update processing is reserved.

Thus, the unified storage server 10 can suppress a shortage of the capacity of the local storage area 62 during data update processing. This can omit re-setting of the splitting ratio for stored data, the re-resetting being caused by a shortage of the capacity of the local storage area 62. Accordingly, the unified storage server 10 can suppress a decline in the data access speed.

The unified storage server 10 also calculates a splitting ratio X, considering the sizes “R (SH and SL)” of the reserved areas which correspond to an access state. Thus, the unified storage server 10 calculates a splitting ratio X so that data having a higher access frequency can use a larger area of the local storage area 62. This suppresses the local storage area 62 being occupied by data on which update processing is performed earlier. The unified storage server 10 also calculates a splitting ratio X so that data having a low access frequency can use the local storage area 62 in accordance with a minimum splitting ratio.

Thus, the unified storage server 10 can set, in the range of the capacity of the local storage area 62, a splitting ratio X for each piece of data to an optimum value corresponding to the data access state. Thus, based on the available capacity of the local storage area 62 and the data access state, the unified storage server 10 can improve the access speed, while maintaining data confidentiality.

Next, a description will be given of examples for a case in which the splitting ratio is fixed and a case in which the splitting ratio is calculated for each piece of data as in the present embodiment.

### Examples

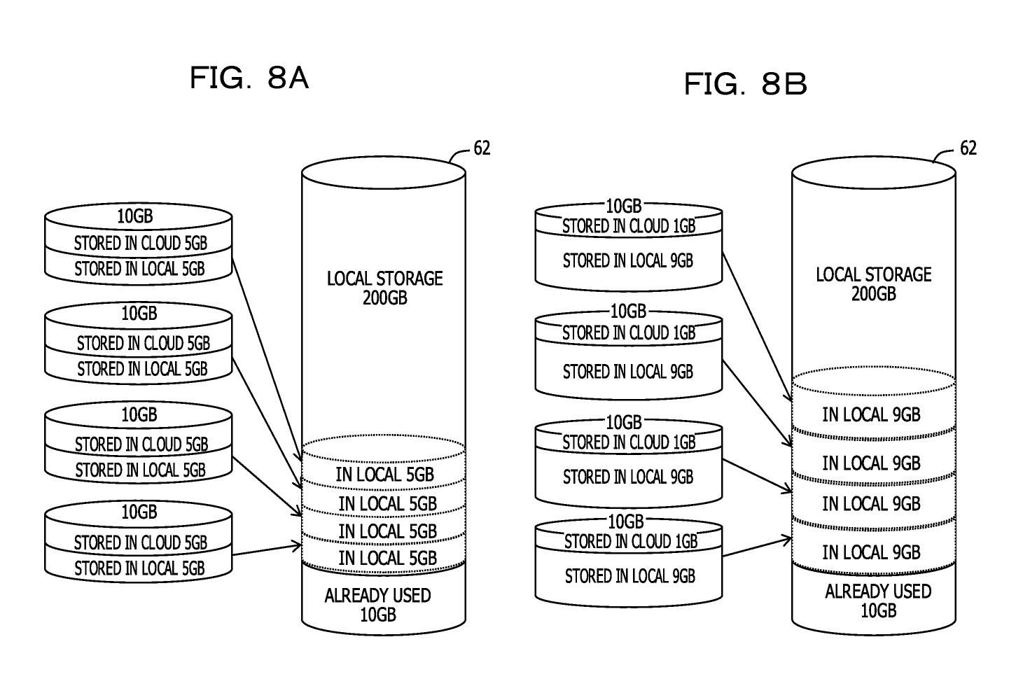

FIGS. 8A and 8B are diagrams illustrating a first example for describing the states of the local storage area 62 when the splitting ratio is fixed and when the splitting ratio is calculated for each piece of data. FIGS. 8A and 8B illustrate a case in which the capacity of the local storage area 62 is large. In this example, the capacity of the local storage area 62 is 200 gigabytes (GB), and 10 GB of the capacity has been used. That is, the available capacity of the local storage area 62 is 190 GB. In this example, a description will be given of a case in which four pieces of encrypted 10 GB data are stored.

FIG. 8A is a diagram illustrating the state of the local storage area 62 when the splitting ratio is fixed. The splitting ratio in this example is 0.5. Thus, the unified storage server 10 stores 5 GB data in each of the local storage area 62 and the cloud storage area 72. When four pieces of 10 GB data are stored, 20 (=5×4) GB data is stored in the local storage area 62. In this case, although the available capacity of the local storage area 62 is sufficient, only 50% of the data is stored in the local storage area 62.

FIG. 8B is a diagram illustrating the state of the local storage area 62 when the splitting ratio is calculated for each piece of data. The unified storage server 10 calculates a splitting ratio for each piece of data in accordance with the splitting-ratio calculation method illustrated in FIG. 7. In this case, the available capacity of the local storage area 62 is sufficient. Accordingly, the unified storage server 10 calculates a splitting ratio “0.9”, which is a maximum value, for each piece of data. The unified storage server 10 stores 9 GB data in the local storage area 62 and stores 1 GB data in the cloud storage area 72.

When four pieces of 10 GB data are stored, 36 (=9×4) GB data is stored in the local storage area 62. In this case, since the available capacity of the local storage area 62 is sufficient, the unified storage server 10 calculates a splitting ratio “0.9”, which is a maximum value. Since the ratio of the data stored in the local storage area 62 is high, the unified storage server 10 can access the data at high speed.

As described above, the unified storage server 10 in the present embodiment calculates a splitting ratio X for data, considering the available capacity of the local storage area 62. Accordingly, it is possible to more efficiently use the local storage area 62, and it is also possible to improve the data access speed. Since the local storage area 62 can be used more efficiently, hardware resources can be used effectively.

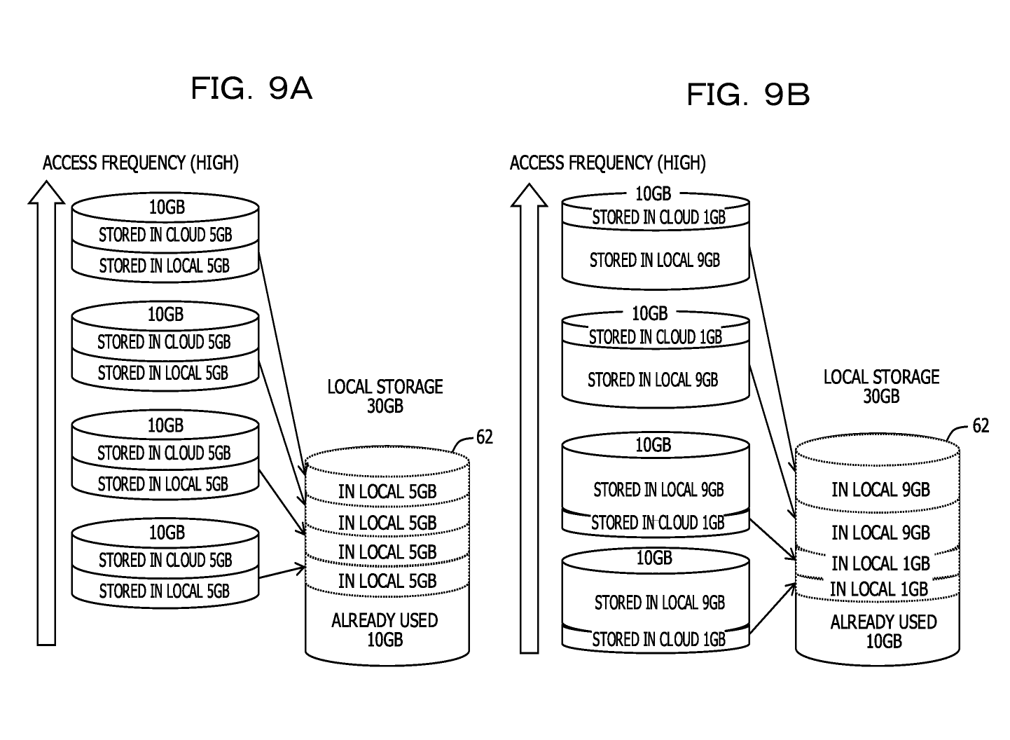

FIGS. 9A and 9B are diagrams illustrating a second example for describing the states of the local storage area 62 when the splitting ratio is fixed and when the splitting ratio is calculated for each piece of data. FIGS. 9A and 9B illustrate a case in which the capacity of the local storage area 62 is small. In this example, the capacity of the local storage area 62 is 30 GB, and 10 GB of the capacity has been used. That is, the available capacity of the local storage area 62 is 20 GB. A case in which four pieces of encrypted 10 GB data are stored will be described, as in the case illustrated in FIGS. 8A and 8B. The access frequencies of the individual pieces of data are different from each other.

FIG. 9A is a diagram illustrating the state of the local storage area 62 when the splitting ratio is fixed. In this example, the splitting ratio is 0.5. As in FIG. 8A, the unified storage server 10 stores 5 GB data in each of the local storage area 62 and the cloud storage area 72. Regardless of the access frequencies, the data splitting ratios are the same. Thus, the splitting ratio for the data having a high access frequency and the splitting ratio for the data having a low access frequency have the same value.

FIG. 9B is a diagram illustrating the state of the local storage area 62 when the splitting ratio is calculated for each piece of data. The unified storage server 10 in the present embodiment calculates a splitting ratio X for data, considering the access frequency of the data.

In this case, the unified storage server 10 calculates a high splitting ratio “0.9” for data having a high access frequency and calculates a low splitting ratio “0.1” for data having a low access frequency. In accordance with the splitting ratio “0.9”, the unified storage server 10 stores 9 GB data in the local storage area 62 and stores 1 GB data in the cloud storage area 72. Also, in accordance with the splitting ratio “0.1”, the unified storage server 10 stores encrypted 1 GB data in the local storage area 62 and stores encrypted 9 GB data in the cloud storage area 72.

As described above, the unified storage server 10 in the present embodiment calculates a splitting ratio X for each piece of data, considering the access frequency of the data. Thus, the unified storage server 10 calculates a large splitting ratio for data having a high access frequency and calculates a low splitting ratio for data having a low access frequency. As a result, data having a high access frequency is stored in the local storage area 62 at a high rate. Accordingly, the unified storage server 10 can improve the access speed of data having a high access frequency.

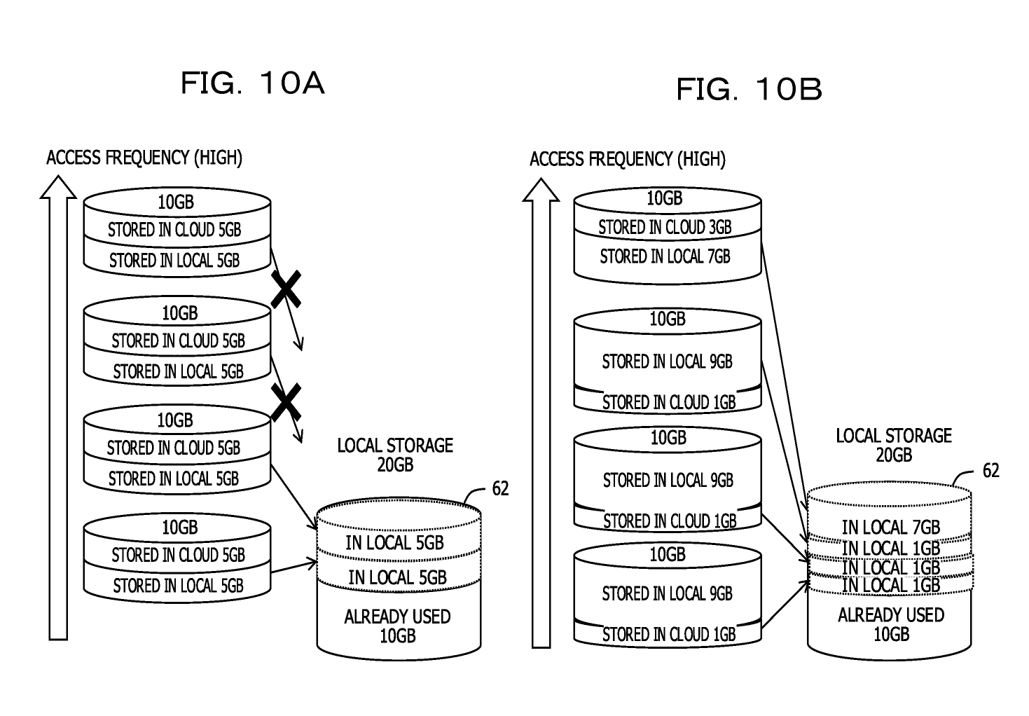

FIGS. 10A and 10B are diagrams illustrating a third example for describing the states of the local storage area 62 when the splitting ratio is fixed and when the splitting ratio is calculated for each piece of data. FIGS. 10A and 10B illustrate a case in which the capacity of the local storage area 62 is not sufficient. In this example, the capacity of the local storage area 62 is 20 GB, and 10 GB of the capacity has been used. That is, the available capacity of the local storage area 62 is 10 GB. A description will be given of a case in which four pieces of encrypted 10 GB data are stored, as in FIGS. 8A and 8B. Also, the access frequencies of the individual pieces of data are different from each other.

FIG. 10A is a diagram illustrating the state of the local storage area 62 when the splitting ratio is fixed. In this example, the splitting ratio is 0.5. As in FIG. 8A, the unified storage server 10 stores 5 GB data in each of the local storage area 62 and the cloud storage area 72. However, since the available capacity of the local storage area 62 is 10 GB, two pieces of data are not stored in the unified storage server 10.

FIG. 10B is a diagram illustrating the state of the local storage area 62 when the splitting ratio is calculated for each piece of data. The unified storage server 10 in the present embodiment calculates a splitting ratio X for data, considering the available capacity of the local storage area 62 and the access frequency of the data.

In this case, the unified storage server 10 calculates a splitting ratio “0.3” for data having the highest access frequency. The unified storage server 10 also calculates a splitting ratio “0.1” for data other than the data having the highest access frequency. Thus, the area used in the local storage area 62 is 10 GB. Accordingly, the unified storage server 10 can store all of the four pieces of data.

Thus, the unified storage server 10 in the present embodiment calculates a splitting ratio for data, based on the available capacity of the local storage area 62 and the access state of each piece of data. Accordingly, even when the available capacity of the local storage area 62 is small, a splitting ratio can be calculated in the range of the available capacity of the local storage area 62, as illustrated in FIG. 10B.

In addition, as illustrated in FIG. 10B, a splitting ratio for data having a high access frequency can be increased and the access speed of data having a high access frequency can be improved in the range of the available capacity of the local storage area 62. Accordingly, under a condition that the capacity of the local storage area 62 is limited, the unified storage server 10 in the present embodiment can improve the access speed.

Also, since the unified storage server 10 calculates a splitting ratio based on the information that can be obtained during data update, it is possible to suppress overhead for changing the splitting ratio.

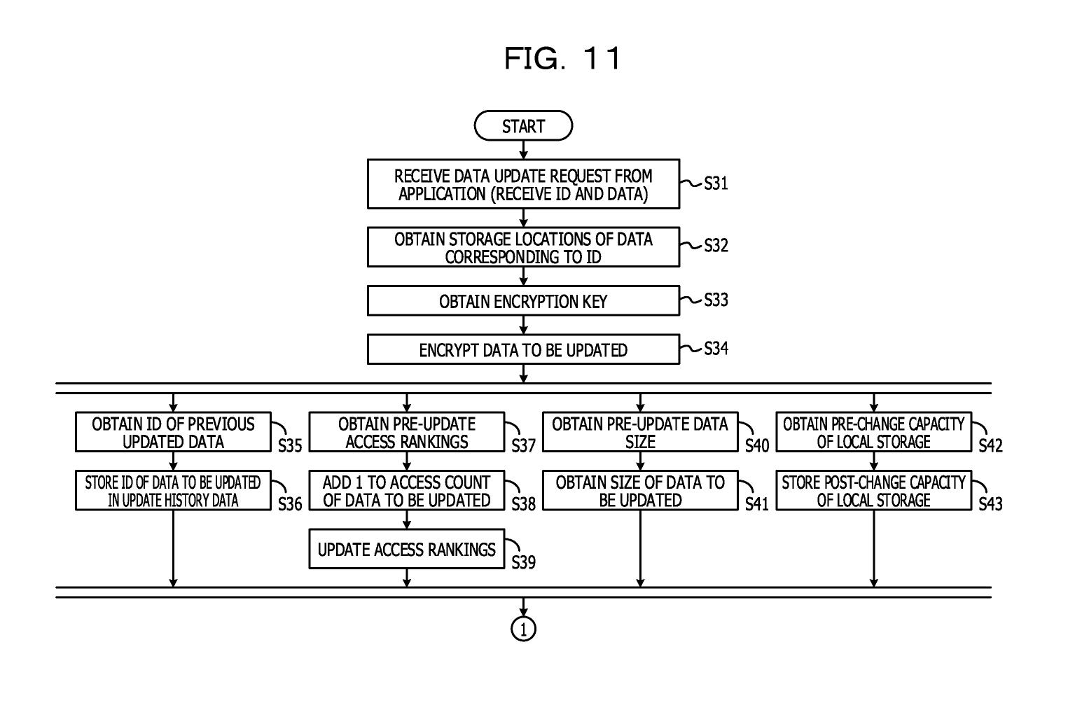

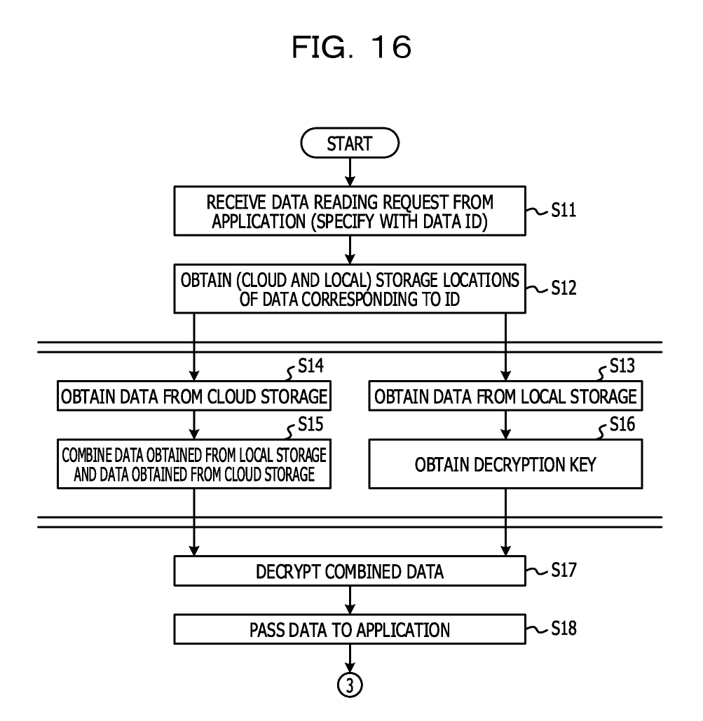

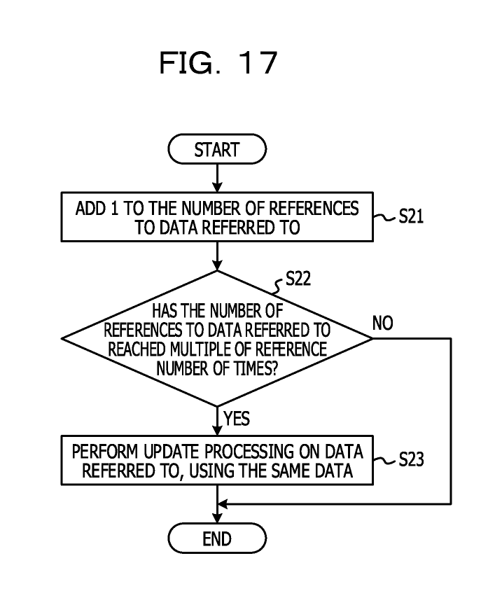

Next, data update processing will be described with reference to FIGS. 11 to 15. The data referring processing is described later with reference to FIGS. 16 and 17.

[Data Update Processing]

FIG. 11 is a first flowchart for describing data update processing performed by the encrypting and splitting module 221 (FIG. 3) in the unified storage server 10 in the present embodiment.

In S31, the encrypting and splitting module 221 receives a data update request from the application (FIG. 1) that runs on the application server 20. In this case, the encrypting and splitting module 221 obtains the data ID of data to be updated and the data to be updated.

In S32, by referring to the storage-location management data 231 (FIG. 3) in the management information database 230, the encrypting and splitting module 221 obtains the storage locations of data corresponding to the specified data ID. The data has been split and stored in the cloud storage server 70 and the local storage server 60. For example, the storage locations of the data represent addresses in the cloud storage area 72 and the local storage area 62 where part of the data is stored.

In S33, the encrypting and splitting module 221 reads, from the nonvolatile memory 202 (FIG. 2), the encryption key 240 for encrypting the data to be updated.

In S34, in accordance with the read encryption key 240, the encrypting and splitting module 221 encrypts the data to be updated.

The encrypting and splitting module 221 performs, for example, processes in steps S35 and S36, steps S37 to S39, steps S40 and S41, and steps S42 and S43 in parallel.

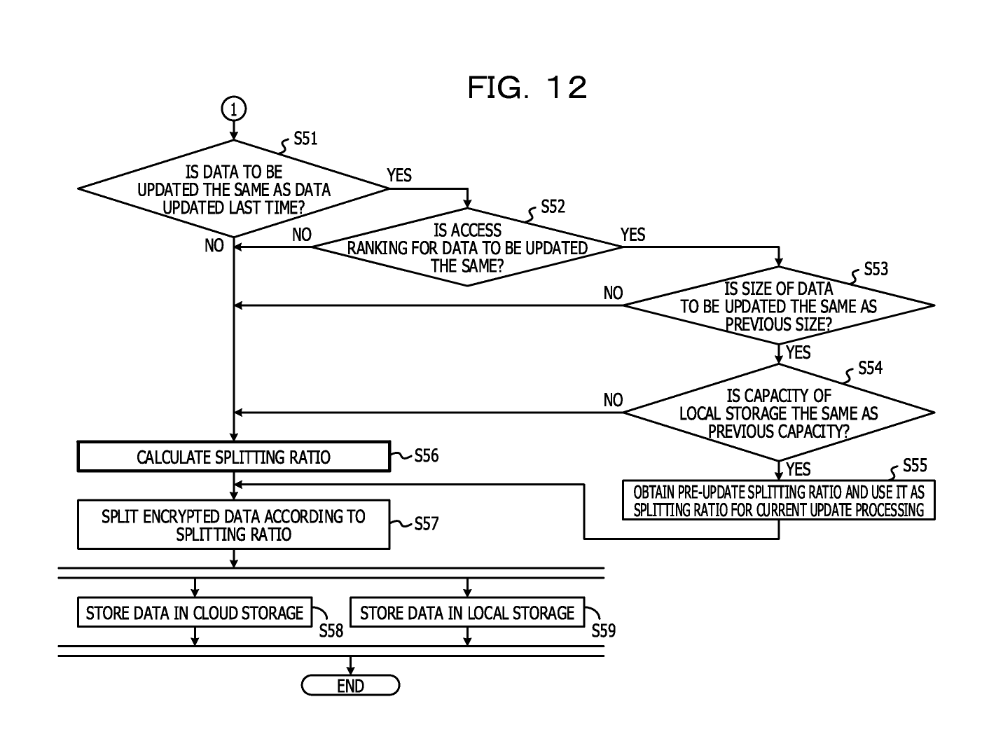

In S35, by referring to the update history data 232 in the management information database 230, the encrypting and splitting module 221 obtains the ID of data on which the update processing was performed last time. The obtained information is used in step S51 in FIG. 12 described below.

In S36, the encrypting and splitting module 221 stores the data ID of the data to be updated this time in the update history data 232.

In S37, by referring to the access-ranking information 233 in the management information database 230, the encrypting and splitting module 221 obtains the access rankings for respective IDs of pre-update data. The obtained information is used in step S52 in FIG. 12 described below.

In S38, the encrypting and splitting module 221 increments the access count for the data ID of the data to be updated. The encrypting and splitting module 221 then updates the access counts to the access-ranking information 233 (FIG. 5).

In S39, based on the updated access count (“the number of references”+“the number of updates”) for each data ID, the encrypting and splitting module 221 calculates the access ranking for the data ID of the data to be updated. The encrypting and splitting module 221 then updates the access rankings to the access-ranking information 233 (FIG. 5).

In S40, the encrypting and splitting module 221 obtains the size of pre-update data corresponding to the data ID of the data be updated. By referring to the item “size” in the access-ranking information 233, the encrypting and splitting module 221 obtains the size of the pre-update data corresponding to the data ID of the data to be updated. The obtained information is used in step S53 in FIG. 12 described below.

In S41, the encrypting and splitting module 221 obtains the size of post-update data corresponding to the data ID of the data to be updated (i.e., the size of the data to be updated). The size of the data to be updated is the post-encryption size of the data to be updated.

In S42, when the capacity of the local storage area 62 changes, the encrypting and splitting module 221 obtains the pre-change capacity of the local storage area 62. For example, when the storage device fails or a storage device is added, the capacity of the local storage area 62 may change in the middle of an operation.

In S43, when the capacity of the local storage area 62 changes, the encrypting and splitting module 221 obtains the post-change capacity of the local storage area 62. As described above, the capacity of the local storage area 62 may change in the middle of an operation. Thus, each time the splitting ratio X is calculated, the encrypting and splitting module 221 obtains the capacity of the local storage area 62. Subsequent processes will be described below with reference to a flowchart illustrated in FIG. 12.

FIG. 12 is a second flowchart illustrating data update processing performed by the encrypting and splitting module 221. In accordance with steps S51 to S55, the encrypting and splitting module 221 determines a case in which processing for calculating a splitting ratio for the data ID of the data to be updated may be omitted.

In S51, the encrypting and splitting module 221 determines whether or not the data ID of the data to be updated is the same as the data ID on which the previous update processing was performed (step S35). That is, the encrypting and splitting module 221 determines whether or not the update processing on the same data ID is continuously performed.

In S52, when the update processing on the same data ID is continuously performed (YES in S51), the encrypting and splitting module 221 determines whether or not the access ranking for the data ID of the data to be updated has changed. The encrypting and splitting module 221 compares the pre-update access ranking for the data ID of the data to be updated (step S37) with the post-update access ranking for the data ID of the data to be updated (step S39).

When the access ranking for the data ID of the data to be updated has not changed (YES in S52), the process proceeds to S53 in which the encrypting and splitting module 221 determines whether or not the size of the pre-update data and the size of the post-update data are the same. The encrypting and splitting module 221 compares the pre-update size of the data corresponding to the data ID of the data to be updated (step S40) with the size of the data to be updated (step S41).

When the size of the pre-update data and the size of the post-update data are the same (YES in S53), the process proceeds to S54 in which the encrypting and splitting module 221 further determines whether or not the capacities of the local storage area 62 (steps S42 and S43) are the same.

When the capacity of the local storage area 62 has not changed (YES in S54), the process proceeds to S55 in which the encrypting and splitting module 221 omits the splitting-ratio calculation processing. The encrypting and splitting module 221 obtains the previous splitting ratio for the data ID of the data to be updated and uses the obtained splitting ratio as a splitting ratio for the current update processing.

As illustrated in steps S51 to S55, the update processing is sequentially performed on the same data ID, and when the access rankings for the data ID of the data to be updated, the sizes of the data corresponding to the data ID, and the capacities of the local storage area 62 are the same, the splitting-ratio calculation processing is omitted. In this case, even if the splitting ratio is calculated, the calculated splitting ratio has the same value as that of the previous splitting ratio for the data ID of the data to be updated. Thus, the encrypting and splitting module 221 omits the splitting-ratio calculation processing (S55).

As a result of omitting the splitting-ratio calculation processing, the encrypting and splitting module 221 can reduce the load on the CPU 101. Also, as a result of omitting the splitting-ratio calculation processing, the encrypting and splitting module 221 can perform the data update processing at high speed.

Even when the access rankings for the data ID of the data to be updated, the sizes of the data corresponding to the data ID, and the capacities of the local storage area 62 are the same, the encrypting and splitting module 221 calculates a splitting ratio, when the previous update processing was performed on a different data ID. In this case, since there are cases in which an access ranking other than the access ranking for the data ID of the data to be updated has changed, the splitting ratio calculated by the encrypting and splitting module 221 may differ from the previous splitting ratio for the data ID of the data to be updated. Accordingly, the encrypting and splitting module 221 re-calculates the splitting ratio.

On the other hand, when the update processing has not been continuously performed on the same data ID, when the access ranking for the data ID of data to be updated has changed, when the sizes of the pre-update data and the post-update data are not the same, or when the capacity of the local storage area 62 has changed, the encrypting and splitting module 221 calculates a splitting ratio for the data to be updated.

In S56, the encrypting and splitting module 221 calculates a splitting ratio for the data to be updated. Details of this process are described later with reference to flowcharts in FIGS. 13 and 14.

In S57, the data that was encrypted in step S34 and that is to be updated is split according to the calculated splitting ratio.

In S58, the encrypting and splitting module 221 stores the data to be updated, the data being split in accordance with the splitting ratio X and being to be stored in the cloud storage area 72, in the cloud storage area 72.

In S59, the encrypting and splitting module 221 stores the data to be updated, the data being split in accordance with the splitting ratio X and being to be stored in the local storage area 62, in the local storage area 62.

[Splitting-Ratio Calculation Processing (S56 in FIG. 12)]

FIG. 13 is a first flowchart illustrating processing for calculating a splitting ratio for the data to be updated.

In S61, by referring to the access-ranking information 233 in the management information database 230, the encrypting and splitting module 221 obtains the access rankings for respective data IDs.

In S62, the encrypting and splitting module 221 initializes a variable n, the variable “SH”, and the variable “SL” to values “0”.

In S63, the encrypting and splitting module 221 determines whether or not the nth data has been stored in the local storage and the cloud storage area 72. When the nth data has not been stored in the local storage and the cloud storage area 72 (NO in S63), the encrypting and splitting module 221 ends the processing for calculating the sizes “SH” and “SL” of the reserved areas.

when the nth data has been stored (YES in S63), the process proceeds to S64 in which the encrypting and splitting module 221 determines whether or not the access ranking for the nth data is higher than or equal to the access ranking for the data ID of the data to be updated.

When the access ranking for the nth data is higher than or equal to the access ranking for the data ID of the data to be updated (YES in S64), the process proceeds to S65 in which the encrypting and splitting module 221 calculates the size “SH” of the reserved area in accordance with equation 3:

SH=SH+“nth-data size”×Dmax−“the size of data included in the nth data and stored in the local storage area 62” equation 3

The size “SH” of the reserved area in equation 3 indicates the capacity of the local storage area 62, the capacity being to be reserved when data is assumed to be split using a maximum splitting ratio Dmax. The splitting ratio Dmax is the upper-limit value of the splitting ratio. In the present embodiment, the splitting ratio Dmax has, for example, a value “0.9”.

The encrypting and splitting module 221 multiplies the size of the data having a data ID whose access ranking is higher than or equal to that of the data ID of the data to be updated by the upper-limit value “Dmax” of the splitting ratio (“data size”×Dmax). By doing so, the encrypting and splitting module 221 calculates the size when the data is assumed to be split according to the maximum splitting ratio “Dmax”.

The encrypting and splitting module 221 then calculates a difference between the calculated multiplication value and the size of data already stored in the local storage area 62 (“data size”×Dmax−“the size of data stored in the local storage area 62”). Thus, when data is assumed to be split according to the maximum splitting ratio “Dmax”, the encrypting and splitting module 221 calculates the size “SH” of the local storage area 62 which is to be additionally reserved.

The encrypting and splitting module 221 calculates values “SH” for all data IDs whose access rankings are higher than or equal to the access ranking for the data ID of the data to be updated and totals the values “SH” to thereby calculate a final value “SH”. As the splitting ratio for a data ID whose access ranking is the same as or higher than that of the data ID of the data to be updated becomes smaller relative to the splitting ratio “Dmax”, the value “SH” becomes a larger value.

On the other hand, when the access ranking for the nth data is lower than the access ranking for the data ID of the data to be updated (NO in S64), the process proceeds to S66 in which the encrypting and splitting module 221 calculates the size “SL” of the reserved area in accordance with equation 4.

SL=SL+“nth data size”×Dmin−“the size of data included in the nth data and stored in the local storage area 62” equation 4

The size “SL” of the reserved area in equation 4 indicates the capacity of the local storage area 62 which is not used when the data is assumed to be split using the maximum splitting ratio “Dmin”. The splitting ratio “Dmin” is a lower-limit value of the splitting ratio. In the present embodiment, the splitting ratio Dmin has, for example, a value “0.1”.

The encrypting and splitting module 221 multiplies the size of data having a data ID whose access ranking is lower than the access ranking for the data ID of the data to be updated by the lower-limit value “Dmin” of the splitting ratio (“data size”×Dmin). By doing so, the encrypting and splitting module 221 calculates the size when data is assumed to be split according to the minimum splitting ratio “Dmin”.

The encrypting and splitting module 221 then calculates a difference between the calculated multiplication value and the size of the data already stored in the local storage area 62 (“data size”×Dmin−“the size of the data stored in the local storage area 62”). By doing so, the encrypting and splitting module 221 calculates the size “SL” of the local storage area 62 which is not used when the data is assumed to be split according to the minimum splitting ratio “Dmin”.

The encrypting and splitting module 221 calculates values “SL” for all data IDs whose access rankings are lower than the access ranking for the data ID of the data to be updated and totals the values “SL” to thereby calculate a final value “SL”. As the splitting ratio for a data ID whose access ranking is lower than that of the data ID of the data to be updated becomes larger relative to the splitting ratio “Dmin”, the value “SL” becomes a larger negative value.

After steps S65 and S66, in S67, the encrypting and splitting module 221 increments the value of the variable “n”. The encrypting and splitting module 221 then returns to step S63 and re-determines whether or not the nth data has been stored in the local storage and the cloud storage area 72.

When the nth data has not been stored in the local storage and the cloud storage area 72 (NO in S63), the encrypting and splitting module 221 calculates a splitting ratio in accordance with the calculated sizes “SH” and “SL” of the reserved areas.

Next, the processing for calculating a splitting ratio in accordance with the calculated sizes “SH” and “SL” of the reserved areas will be described with reference to a flowchart in FIG. 14.

FIG. 14 is a second flowchart illustrating the processing for calculating the splitting ratio for the data to be updated.

In S71, the encrypting and splitting module 221 calculates a total size “R” of the reserved areas in accordance with equation 5:

R=SH+SL−D×Dmax equation 5

The variable D in equation 5 indicates the size of the data to be updated. The value “D×Dmax” indicates the size “SH” of the reserved area for the data to be updated. The reserved area “SH” calculated in step S65 also includes the size of the reserved area for the data to be updated. Thus, the encrypting and splitting module 221 excludes the size “D×Dmax” of the reserved area for the data to be updated, by subtracting the size “D×Dmax” from the total size “R” of the reserved areas.

In S72, the encrypting and splitting module 221 determines whether or not the total size R of the reserved areas has a negative value. For example, when the splitting ratio for a data ID whose access ranking is lower than the access ranking for the data ID of the data to be updated is larger than the splitting ratio for the data to be updated, the total size “R” of the reserved areas may become a negative value.

When the total size “R” of the reserved areas has a negative value (YES in S72), the process proceeds to S73 in which the encrypting and splitting module 221 sets the total size R of the reserved areas to a value “0”. When the total size R of the reserved areas has a negative value, the encrypting and splitting module 221 resets the total size R of the reserved areas to a value “0” in order to indicate that no area is to be reserved.

In S74, the encrypting and splitting module 221 calculates the available capacity “AC” of the local storage area 62 which can be used for the data to be updated, in accordance with equation 2 (AC=S−R+DS) described above with reference to FIG. 7.

As described above with reference to FIG. 7, the encrypting and splitting module 221 subtracts the total size “R” of the reserved areas from a value obtained by adding the size “DS” of the local storage area 62 being used for the data to be updated to the available capacity S of the local storage area 62, to thereby calculate the value “AC”.

In S75, the encrypting and splitting module 221 calculates a splitting ratio in accordance with equation 1 (X=AC/D) described above with reference to FIG. 7. The encrypting and splitting module 221 calculates a splitting ratio “X” for the data to be updated, by dividing the available capacity “AC” of the local storage area 62 which can be used for the data to be updated by the size “D” of the data to be updated.

In S76, the encrypting and splitting module 221 determines whether or not the splitting ratio “X” calculated in step S75 is smaller than the lower-limit value “Dmin” of the splitting ratio.

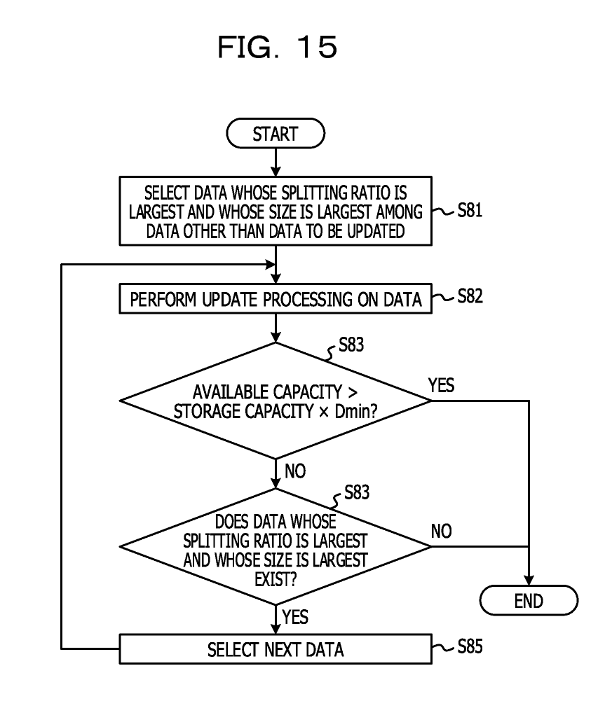

When the calculated splitting ratio “X” is smaller than the lower-limit value “Dmin” of the splitting ratio (YES in S76), this indicates that, in S77, the data is not storable in the local storage area 62, even if the data to be updated is split according to the lower-limit value “Dmin” of the splitting ratio. That is, when the calculated splitting ratio “X” is smaller than the lower-limit value “Dmin”, this indicates that the available capacity of the local storage area 62 is not sufficient. Thus, the encrypting and splitting module 221 performs update processing on data IDs other than the data ID of the data to be updated. By doing so, the encrypting and splitting module 221 increases the available capacity of the local storage area 62. Details of the processing are described later with reference to a flowchart illustrated in FIG. 15.

In S78, the encrypting and splitting module 221 sets the splitting ratio for the data to be updated to the lower-limit value “Dmin” of the splitting ratio. Since the available capacity of the local storage area 62 was increased in accordance with step S77, the encrypting and splitting module 221 can set the splitting ratio X to the lower-limit value “Dmin”.

When the calculated splitting ratio “X” is larger than or equal to the lower-limit value “Dmin” of the splitting ratio (NO in S76), the process proceeds to S79 in which the encrypting and splitting module 221 determines whether or not the calculated splitting ratio “X” is larger than or equal to the upper-limit value “Dmax” of the splitting ratio.

When the calculated splitting ratio “X” is larger than the upper-limit value “Dmax” of the splitting ratio (YES in S79), this indicates, in S80, that the data to be updated can be split according to the upper-limit value “Dmax” of the splitting ratio. That is, when the calculated splitting ratio “X” is larger than the upper-limit value “Dmax”, this indicates that the available capacity of the local storage area 62 is sufficient. Accordingly, the encrypting and splitting module 221 sets the splitting ratio for the data to be updated to the upper-limit value “Dmax” of the splitting ratio.

Accordingly, when the calculated splitting ratio “X” is higher than or equal to the lower-limit value “Dmin” of the splitting ratio and is lower than or equal to the upper-limit value “Dmax” of the splitting ratio, the encrypting and splitting module 221 sets the calculated splitting ratio “X” as the splitting ratio for the data to be updated.

As described above, when the splitting ratio “X” calculated in equation 1 exceeds the upper-limit value “Dmax”, the encrypting and splitting module 221 sets the value “Dmax” as the splitting ratio “X”. Alternatively, when the splitting ratio “X” calculated in equation 1 falls below the upper-limit value “Dmin”, the encrypting and splitting module 221 sets the value “Dmin” as the splitting ratio “X”. As a result, a case in which the data is stored in only one of the storage devices is avoided, and the confidentiality of the data is maintained. In addition, since the upper-limit value and the lower-limit value of the splitting ratio are set, a minimum ratio that ensures data confidentiality is obtained.

FIG. 15 is a flowchart illustrating the update processing (S77 in FIG. 14) on the data IDs other than the data ID of the data to be updated. As described above with reference to the flowchart illustrated in FIG. 14, since the available capacity of the local storage area 62 is not sufficient, the encrypting and splitting module 221 performs update processing on the data IDs other than the data ID of the data to be updated.

In this example, when the calculated splitting ratio “X” is smaller than the lower-limit value “Dmin” of the splitting ratio (YES in S76 in FIG. 14), the encrypting and splitting module 221 performs the processing illustrated in the flowchart in FIG. 15. The present disclosure, however, is not limited to this example. When the capacity of the local storage area 62 falls below a reference value, the encrypting and splitting module 221 may perform the processing in the flowchart in FIG. 15.

In S81, the encrypting and splitting module 221 selects the data ID whose splitting ratio is the largest among the splitting ratios of the data IDs other than the data ID of the data to be updated. When there are a plurality of IDs of data whose splitting ratios are the largest, the encrypting and splitting module 221 selects the ID of data whose data size is the largest among the IDs of data whose splitting ratios are the largest.

In S82, the encrypting and splitting module 221 performs update processing on the selected data ID. In accordance with the flowcharts in FIGS. 16 and 17 described below, the encrypting and splitting module 221 performs referring processing on the selected data ID to obtain the data having the selected data ID. Then, in accordance with the flowcharts illustrated in FIGS. 11 to 14, the encrypting and splitting module 221 performs update processing on the selected data ID by using the obtained data as data to be updated.

As a result, the splitting ratio for the selected data ID is calculated, and the data is stored in the cloud storage area 72 and the local storage area 62 in accordance with the calculated splitting ratio. Since the splitting ratio is re-calculated, the calculated splitting ratio may be smaller than the splitting ratio before the calculation.

The splitting-ratio calculation processing is also performed only during data update processing. Accordingly, the splitting ratio for a data ID on which the update processing is not performed for a long time may be set to a large value, even if the access ranking is low. Since the splitting ratio for the data ID is re-calculated, the calculated splitting ratio may become smaller than the pre-calculation splitting ratio.

In such a case, the data corresponding to the data ID is re-stored in the local storage area 62 and the cloud storage area 72 in accordance with the calculated splitting ratio, so that the available capacity of the local storage area 62 increases.

In S83, the encrypting and splitting module 221 determines whether or not the available capacity of the local storage area 62 is larger than the size “D×Dmin” of the local storage which is to be used when the data to be updated is split according to the lower-limit value “Dmin” of the splitting ratio. That is, the encrypting and splitting module 221 determines whether or not the capacity of the local storage area 62 which is to be used for a case in which the data to be updated is to be split according to the splitting ratio “Dmin” has been reserved.

When the capacity of the local storage area 62 has not been reserved (NO in S83), the process proceeds to S84 in which the encrypting and splitting module 221 selects a data ID whose splitting ratio is the next largest and whose data size is the largest. The process then proceeds to step S82 in which the encrypting and splitting module 221 similarly performs update processing on the selected data ID.

As described above, the encrypting and splitting module 221 performs the update processing on data IDs other the data ID of the data to be updated. As a result, the encrypting and splitting module 221 can reserve the capacity of the local storage area 62 which is to be used for a case in which the data to be updated is to be split according to the splitting ratio “Dmin”. When the capacity of the local storage area 62 has been reserved (YES in S83), the encrypting and splitting module 221 returns the process to the process in step S78 in FIG. 14.

In the flowchart illustrated in FIG. 15, the update processing is performed on the data IDs in descending order of the splitting ratios thereof. The present disclosure, however, is not limited to this example. For example, the encrypting and splitting module 221 may perform the update processing in the order of data IDs on which the update processing has not been performed for a long period of time. Alternatively, for example, the encrypting and splitting module 221 may perform the update processing on all data IDs other than the data ID of the data to be updated.

[Data Referring Processing]

As described above with reference to FIGS. 11 to 15, the encrypting and splitting module 221 performs splitting-ratio calculation and data splitting based on the splitting ratio, when data update processing is performed. However, when the splitting ratio is calculated only during data update processing, the splitting ratio for data that is repeatedly referred to is not updated.

Since data that is repeatedly referred to has a high access frequency, it is desirable that the access speed be improved by setting the splitting ratio high. However, since no splitting ratio is calculated during data referring processing, the splitting ratio remains low, and the access speed does not improve. Accordingly, when the number of references to data exceeds a reference number of times, the encrypting and splitting module 221 performs data update processing, based on the data referred to.

FIG. 16 is a first flowchart illustrating the data referring processing performed by the encrypting and splitting module 221.

In S11, the encrypting and splitting module 221 receives a data reading request from the application. In this case, the encrypting and splitting module 221 obtains the data ID of data to be read.

In S12, by referring to the storage-location management data 231 (FIG. 3) in the management information database 230, the encrypting and splitting module 221 obtains the addresses of data corresponding to the specified data ID.

In S13, based on the obtained storage locations, the encrypting and splitting module 221 obtains the data from the local storage server 60.

In S14, in parallel with step S13, the encrypting and splitting module 221 obtains the data from the cloud storage server 70, based on the obtained storage locations.

In S15, the encrypting and splitting module 221 combines the data obtained from the local storage server 60 (S13) and the data obtained from the cloud storage server 70 (S14).

In S16, the encrypting and splitting module 221 reads the decryption key 240 for the data ID from the nonvolatile memory 202 (FIG. 2).

In S17, the encrypting and splitting module 221 decrypts the data corresponding to the data ID, the data being combined in step S15, in accordance with the decryption key 240 read in step S16.

In S18, the encrypting and splitting module 221 outputs the decrypted data to the application. Subsequent processes will now be described with reference to a flowchart in FIG. 17.

FIG. 17 is a second flowchart illustrating the data referring processing performed by the encrypting and splitting module 221.

In S21, the encrypting and splitting module 221 increments the number of references to the data ID.

In S22, the encrypting and splitting module 221 determines whether or not the number of references to the data corresponding to the data ID has reached a multiple of a reference number. The reference number represents an arbitrary number of times.

When the number of references to the data ID has reached a multiple of the reference number (YES in S22), the process proceeds to S23 in which the encrypting and splitting module 221 performs update processing, based on the data read according to the referring processing. That is, the encrypting and splitting module 221 performs the update processing on the data ID once, each time the reference number for the referring processing on the data corresponding to the data ID is reached.

As described above, when the number of references to the data exceeds the reference number during the data referring processing, the encrypting and splitting module 221 performs update processing on the data. Through the above-described processing, the encrypting and splitting module 221 calculates a splitting ratio for the data ID and stores, in the local storage server 60 and the cloud storage server 70, data resulting from splitting according to the splitting ratio.

Thus, the encrypting and splitting module 221 can set an appropriate splitting ratio for a splitting ratio for data on which the referring processing is repeatedly performed. The encrypting and splitting module 221 can set, for example, a large value for a splitting ratio for a data ID having a large number of references. Thus, the encrypting and splitting module 221 can improve the speed of access to the data.

For writing new data, the encrypting and splitting module 221 splits the data in accordance with the lower-limit value “Dmin” of the splitting ratio and stores the split data in the cloud storage area 72 and the local storage area 62. Alternatively, for writing new data, the encrypting and splitting module 221 splits the data in accordance with a pre-set arbitrary splitting ratio and stores the split data in the cloud storage area 72 and the local storage area 62.

### Specific Examples

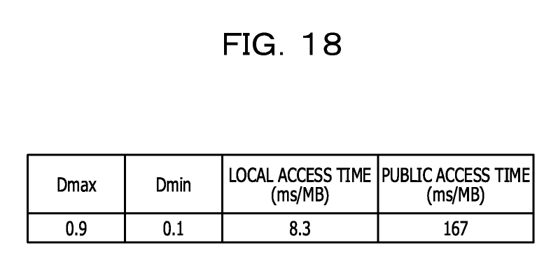

FIG. 18 is a table illustrating, in a specific example, the time of access to a storage and an upper-limit value and a lower-limit value of the splitting ratio. According to FIG. 18, in the present embodiment, the upper-limit value “Dmax” of the splitting ratio is set to a value “0.9”, and the lower-limit value “Dmin” of the splitting ratio is set to a value “0.1”. In the present embodiment, the time of access to data stored in the cloud storage server 70 is 8.3 milliseconds/megabyte (ms/MB)”. The time of access to data stored in the local storage server 60 is 167 ms/MB.

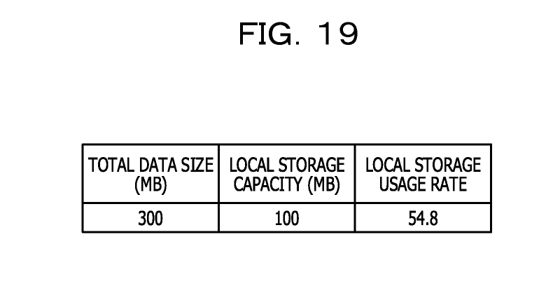

FIG. 19 is a table illustrating, in a specific example, information about the local storage area 62 and the size of data. According to FIG. 19, in the present embodiment, the total size of pieces of data stored in the local storage area 62 and the cloud storage area 72 is 300 MB. The capacity of the local storage area 62 is 100 MB. That is, in this example, data having a size that is three times the capacity of the local storage area 62 is stored in the local storage and the cloud storage area 72.

In addition, according to FIG. 19, the usage rate of the local storage area 62 at this point is 54.8%. That is, this means that, at this point, no data is stored in a 45.2% area in the local storage area 62, and the usage efficiency is not high.

Next, a description will be given of a case in which, in the state illustrated in FIGS. 18 and 19, update processing is performed on data “Data5”.

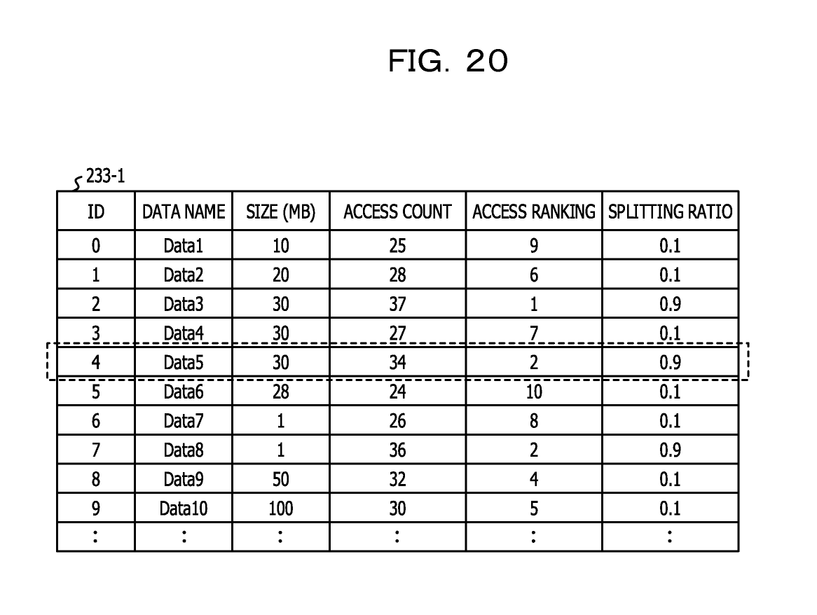

FIG. 20 illustrates access-ranking information 233-1 when the update processing is performed on the data “Data5”. The access-ranking information 233-1 in FIG. 20 is information in which the access count, the access ranking, and the splitting ratio for the data “Data5” are updated in the access-ranking information 233 illustrated in FIG. 5.

In the access-ranking information 233-1 illustrated in FIG. 20, the access count for the data “Data5” having a data ID “4” has been updated from value “33” in the access-ranking information 233 in FIG. 5 to value “34”. Also, since the access count for the data “Data5” has been updated to a value “34” in the access-ranking information 233-1, the access ranking for the data “Data5” has been updated from a value “3” to a value “2”. That is, the access ranking has increased.

In accordance with the updated access-ranking information 233-1, the encrypting and splitting module 221 calculates a splitting ratio for the data “Data5” (FIGS. 13 and 14). According to the access-ranking information 233-1, data whose rankings are higher than or equal to the updated access ranking “2” of the data “Data5” are data Data3 and Data8. Thus, the encrypting and splitting module 221 calculates the size “SH” of reserved areas for the data “Data3”, “Data5”, and “Data8” (S65 in FIG. 13). The encrypting and splitting module 221 also calculates the size “SL” of reserved areas for the data “Data1”, “Data2”, “Data4” to “Data7”, “Data9”, and “Data10” (S66 in FIG. 13).

The encrypting and splitting module 221 then calculates the value “AC” in accordance with the available capacity of the local storage area 62, the calculated total size “R” of the reserved areas, and the size “DS” of the data “Data5” stored in the local storage area 62 (S71 to S74 in FIG. 14). The encrypting and splitting module 221 then calculates a splitting ratio X by dividing the calculated value “AC” by the size “D” of the data “Data5” (S75 in FIG. 14). In this case, the calculated splitting ratio is 0.9.

According to the access-ranking information 233 in FIG. 5, the previous splitting ratio for the data “Data5” is 0.1. Since the update processing has been performed on the data “Data5”, the access ranking for the data “Data5” has increased, and the splitting ratio has increased from 0.1 to 0.9.

According to the update history data 232 illustrated in FIG. 4, the data ID of the data updated last time is Data3 (NO in S51 in FIG. 12). Thus, this case does not correspond to a case in which the same data is continuously updated. Accordingly, this case does not correspond to a case in which the splitting-ratio calculation processing is omitted.

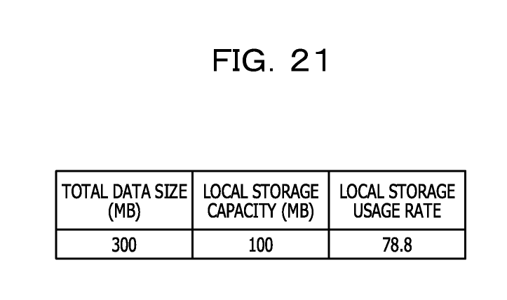

FIG. 21 is a table illustrating information about the local storage and the size of data after the update processing is performed on the data “Data5”. According to FIG. 21, the usage rate of the local storage is 78.8%. That is, as a result of the update processing on the data “Data5”, the usage rate of the local storage has changed from 54.8% to 78.8%. This indicates that the usage rate of the local storage approaches 100% and the local storage is used more efficiently.

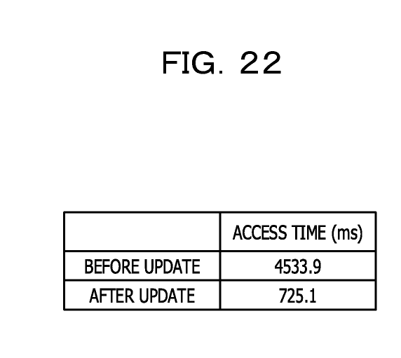

FIG. 22 is a table illustrating the time of access to the data “Data5”. As described above and illustrated in FIG. 18, the time of access to data stored in the cloud storage server is 8.3 ms/MB. The time of access to data stored in the local storage server is 167 ms/MB.

As described above, during update of the data “Data5”, the splitting ratio for the data “Data5” has been updated from the value “0.1” to the value “0.9”. As a result of the increase of the splitting ratio from the value “0.1” to the value “0.9”, the time of access to the data “Data5” has improved from 4533.9 ms to 725.1 ms.

As described above, since the encrypting and splitting module 221 calculates a splitting ratio for each piece of data based on the size of the data and the available capacity of the local storage area 62, it is possible to improve the usage rate of the local storage area 62. Since the encrypting and splitting module 221 further calculates the splitting ratio based on the access state of data, it is possible to improve the speed of access to the data.

[Average Usage Efficiency and Average Access Time]

Next, a description will be given of the average usage efficiencies and the average times of access to the local storage area 62 when the splitting ratio is fixed and when the splitting ratio is calculated for each piece of data.

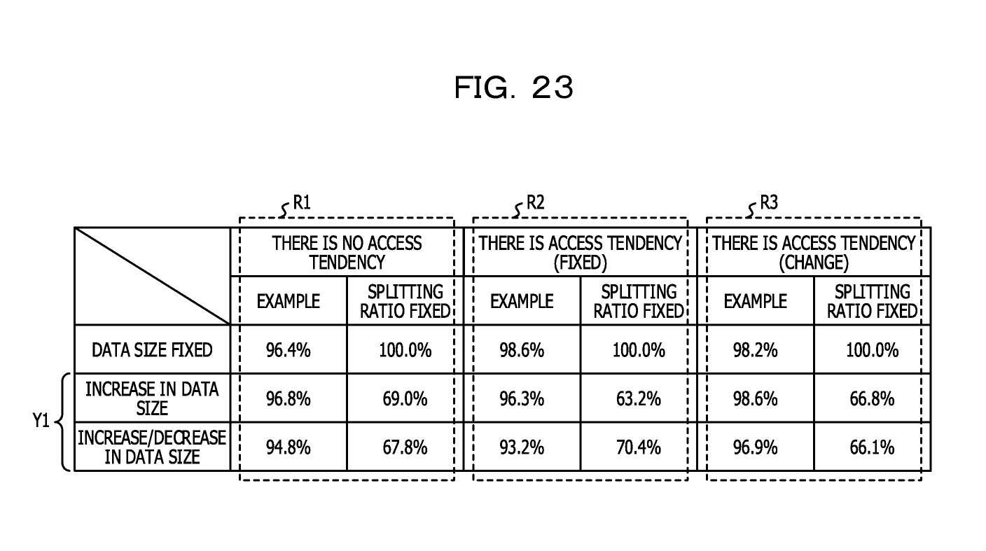

FIG. 23 is a table illustrating the average usage efficiencies of the local storage area 62 when the splitting ratio is fixed and when the splitting ratio is calculated for each piece of data. FIG. 23 indicates that the closer to 100% the usage efficiency is, the higher the usage efficiency is. The average value of the use efficiencies is an average value when a set of 300 rounds of data update processing is executed 10 times.

A column R1 in FIG. 23 indicates the average values of use efficiencies when there is no tendency of access to data. The “tendency of access to data” refers to the tendency of an access frequency pattern for each piece of stored data. A column R1 indicates the average usage efficiencies of the local storage area 62 when the size of data to be updated is fixed, when the data to be updated increases, and the data to be updated increases/decreases.

A column R2 in FIG. 23 indicates the average usage efficiencies when the tendency of access to data is fixed. Similarly to the column R1, the column R2 has the average usage efficiencies of the local storage area 62 when the size of data to be updated is fixed, when data to be updated increases, and when data to be updated increases/decreases. Similarly, a column R3 in FIG. 23 indicates the average usage efficiencies when the tendency of access to data changes.

According to FIG. 23, particularly, when the size of data to be updated increases, when the size of data to be updated increases/decreases (Y1), and when the splitting ratio is fixed, the average usage efficiency of the local storage is close to 100%. That is, when the size of data to be updated changes (Y1) and the splitting ratio for data is fixed, the average usage efficiency of the local storage improves significantly.

As described above, data in the present embodiment is, for example, a database table. Examples of the table include text information, binary information, and so on. Thus, even for the same data ID, the size of data varies.

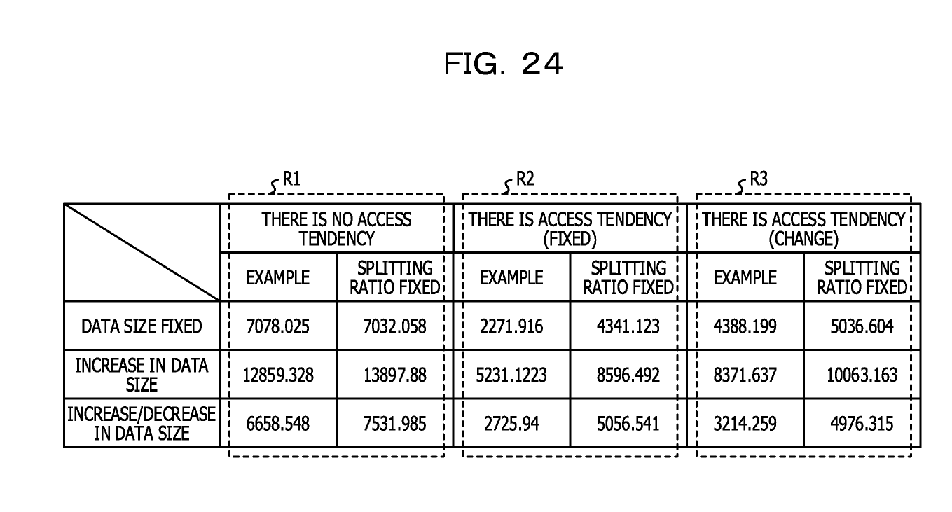

FIG. 24 is a table illustrating the average access times when the splitting ratio is fixed and the splitting ratio is calculated for each piece of data. The average access time is an average value of times taken for data access. A shorter average access time indicates that the access speed is higher. The average access time is an average value when a set of 300 rounds of data update processing is executed 10 times.

The access frequencies in columns R1 to R3 in FIG. 24 are similar to those in FIG. 23. Each of the columns R1 to R3 in FIG. 24 has average access times when the size of data to be updated is fixed, when the data to be updated increases, and the data to be updated increases/decreases, similarly to FIG. 23.

According to FIG. 24, when the splitting ratio is calculated for each piece of data, including a case in which the size of the data to be updated is fixed, the average access time decreases when the splitting ratio is fixed. That is, FIG. 24 indicates that, when the splitting ratio is calculated for each piece of data, the access speed improves when the splitting ratio is fixed. Also, according to FIG. 24, when the tendency of access to data is fixed (R2), the average access time improves significantly.

Thus, according to the unified storage server 10 in the present embodiment, the usage efficiency of the local storage area 62 improves significantly, and the speed of access to each piece of data improves considerably. This makes it possible to efficiently use the hardware resources. Also, even when data is stored in storages in a split manner, it is possible to suppress a reduction in the access speed.

As described above, when access is made to any of a plurality of pieces of data stored in a first storage apparatus and a second storage apparatus in a split manner, the unified storage server 10 in the present embodiment obtains the states of access to the respective pieces of data. The unified storage server 10 calculates a splitting ratio for data to be accessed, based on the access state and the available capacity of the first storage apparatus. The unified storage server 10 then splits the data to be accessed in accordance with the calculated splitting ratio and stores the split pieces of data in the first storage apparatus and the second storage apparatus. The first storage apparatus corresponds to the local storage area 62, and the second storage apparatus corresponds to the cloud storage area 72.

Thus, the unified storage server 10 can calculate, in the range of the capacity of the local storage area, a larger splitting ratio X for data having a higher access frequency. Accordingly, the unified storage server 10 can improve the speed of access to data, while efficiently using the capacity of the local storage area 62.

Also, the unified storage server 10 can suppress a shortage of the capacity of the local storage area 62 during data update processing. This can omit re-setting of the splitting ratio for stored data, the re-resetting being caused by a shortage of the capacity of the local storage area 62. Accordingly, the unified storage server 10 can suppress deterioration of the speed of access to data.

Considering the state of access to data, the unified storage server 10 also calculates a splitting ratio X each time data update processing is performed. That is, since a splitting ratio X is calculated in conjunction with a change in the state of access to data, it is possible to calculate a splitting ratio X corresponding to the change.

The unified storage server 10 in the present embodiment also calculates a splitting ratio for data to be accessed, based on a second available capacity obtained by subtracting a capacity used, in response to subsequent access for data other than the data to be accessed, from a first available capacity of the first storage apparatus.

With this arrangement, the unified storage server 10 calculates a splitting ratio for data to be updated, after reserving the local storage area 62 assumed to be used for each piece of data in accordance with the access state. Thus, since the local storage area 62 used in future update processing is reserved, it is possible to suppress a shortage of the capacity of the local storage area 62 during update processing of data. This can omit re-setting of the splitting ratio for stored data, the re-resetting being caused by a shortage of the capacity of the local storage area 62. Accordingly, the unified storage server 10 can suppress a decline in the data access speed.

The unified storage server 10 in the present embodiment also calculates a second available capacity, based on the access state and the size of each of pieces of data. Thus, the unified storage server 10 can set a splitting ratio X for each piece of data to an optimum value corresponding to the data access state and in the range of the capacity of the local storage area 62. Thus, based on the available capacity of the local storage area 62 and the data access state, the unified storage server 10 can improve the access speed, while maintaining data confidentiality.

In the unified storage server 10 in the present embodiment, the access state is access frequencies of pieces of data in a reference period of time. The unified storage server 10 splits pieces of data having an access frequency that is the same as or higher than that of the data to be accessed, based on a first splitting ratio that is an upper-limit value of a ratio stored in the first storage apparatus. The unified storage server 10 then splits pieces of data having an access frequency that is lower than that of the data to be accessed, based on a second splitting ratio, which is a lower-limit value of the ratio stored in the first storage apparatus. The unified storage server 10 then calculates a second available capacity, based on the capacity of the first storage apparatus which is used when the data is split.

Thus, the unified storage server 10 can calculate a splitting ratio X so that data having a high access frequency can use larger space in the local storage area 62. This suppresses the local storage area 62 being occupied by data on which update processing was performed earlier. The unified storage server 10 also calculates a splitting ratio X so that data having a low access frequency can use the local storage area 62 in accordance with a minimum splitting ratio.

In the unified storage server 10 in the present embodiment, the access is data update. Thus, by calculating a splitting ratio each time data is updated, the unified storage server 10 can calculate an appropriate splitting ratio X for each unit of data to be updated.

In the unified storage server 10 in the present embodiment, the access further includes referring to data. When any of pieces of data is referred to, the unified storage server 10 obtains the number of references to data to be referred to, and calculates a splitting ratio for the data when the number of references reaches the reference number of times. The unified storage server 10 then splits the data in accordance with the calculated splitting ratio and stores the split pieces of data in the first storage apparatus and the second storage apparatus.

Thus, the unified storage server 10 can set an appropriate splitting ratio for a splitting ratio for data on which the referring processing is repeatedly performed. Accordingly, the unified storage server 10 can improve the speed of access to data having a large number of references.

The unified storage server 10 in the present embodiment also calculates a splitting ratio that is higher than or equal to a set second splitting ratio, which is a lower-limit value of a ratio stored in the first storage apparatus, and that is lower than or equal to a set first splitting ratio, which is an upper-limit value of the ratio storage in the first storage apparatus. As a result, a case in which the data is stored in only one of the storage devices is avoided, and the confidentiality of the data is maintained. Thus, since the upper-limit value and the lower-limit value of the splitting ratio are set, a minimum ratio that ensures data confidentiality is obtained.

The unified storage server 10 in the present embodiment also obtains the previous splitting ratio, when the last access, data to be accessed, the access state and the size of the data to be accessed, and the available capacity of the first storage apparatus are the same. The unified storage server 10 then splits the data to be accessed, in accordance with the previous splitting ratio, and stores the split pieces of data in the first storage apparatus and the second storage apparatus. As a result, the unified storage server 10 can omit the splitting-ratio calculation processing in a case in which the splitting-ratio calculation processing may be omitted. Accordingly, the unified storage server 10 can suppress the load on the processing.

Also, when the available capacity of the first storage apparatus is smaller than or equal to a reference value, the unified storage server 10 in the present embodiment calculates a splitting ratio for data other than the data to be accessed. The unified storage server 10 then splits data other than the data to be accessed, in accordance with the calculated splitting ratio, and stores the split pieces of data in the first storage apparatus and the second storage apparatus.

Thus, when the splitting ratio for data other than the data to be accessed is re-calculated, the calculated splitting ratio may become smaller than the splitting ratio before the calculation. Accordingly, the unified storage server 10 can increase the available capacity of the local storage area 62 by re-storing the data corresponding to a data ID in the local storage and the cloud storage area 72 in accordance with the calculated splitting ratio.

### OTHER EMBODIMENTS

The present embodiment has been given of a case in which the unified storage server 10 stores data in the cloud storage area 72 and the local storage area 62. However, the present disclosure is not limited to this example. For example, the unified storage server 10 may split data and store the split pieces of data in two local storage areas included in another local storage server. Similarly, the unified storage server 10 may split data and store the split pieces of data in two cloud storage areas included in different cloud storage servers.

The above description has been given of a case in which the unified storage server 10 in the present embodiment generates an access ranking based on the number of references and the number of updates. The present disclosure, however, is not limited to this example, and the unified storage server 10 may generate an access ranking based only on the number of updates.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
obtaining access states of a plurality of data when accessing to a first target data of the plurality of data is executed, respective data of the plurality of data being split into a certain data and other data, the certain data being stored in a first storage apparatus and the other data being stored in a second storage apparatus;
calculating a splitting ratio for the first target data based on the access states and an available capacity of the first storage apparatus;
splitting the first target data into a first piece of data and a second piece of data in accordance with the calculated splitting ratio;
storing the first piece of data in the first storage apparatus; and
storing the second piece of data in the second storage apparatus.

2. The method according to claim 1, wherein
the calculating calculates the splitting ratio for the first target data, based on a second available capacity obtained by subtracting a capacity used, in response to another accessing made subsequent to the accessing, for data other than the first target data from a first available capacity of the first storage apparatus.

3. The method according to claim 2, further comprising:
calculating the second available capacity based on the access states and sizes of the respective data of the plurality of data.

4. The method according to claim 3, wherein the access states include access frequencies for the respective data of the plurality of data in a reference period of time, and
the calculating of the second available capacity calculates the second available capacity, based on a capacity of the first storage apparatus which is to be used when a first data of the plurality of data and whose access frequency is higher than or equal to the access frequency for the first target data is split based on a first splitting ratio, which is an upper-limit value of a rate for storage in the first storage apparatus, and a second data of the plurality of data and that is other than the first data is split based on a second splitting ratio, which is a lower-limit value of the ratio for storage in the first storage apparatus.

5. The method according to claim 1, wherein the accessing is access for updating the data.

6. The method according to claim 1, wherein the accessing is access for referring to the data,
the method further comprising:
obtaining the number of references to a second target data of the plurality of data when accessing for referring to the second target data is executed;
calculating the splitting ratio for the second data when the number of references reaches a reference number of times;
splitting the second target data into a third piece of data and a fourth piece of data in accordance with the calculated splitting ratio;
storing the third piece of data in the first storage apparatus; and
storing the fourth piece of data in the second storage apparatus.

7. The method according to claim 1, wherein
the calculating calculates the splitting ratio that is higher than or equal to a set second splitting ratio, which is a lower-limit value of a ratio for storage in the first storage apparatus, and that is lower than or equal to a set first splitting ratio, which is an upper-limit value of the ratio for storage in the first storage apparatus.

8. The method according to claim 1, further comprising:
obtaining, when the accessing and previous accessing are the same in the first target data, the access state and a size regarding the first target data, and the available capacity of the first storage apparatus, a previous splitting ratio calculated for the previous accessing; and
splitting the first target data in accordance with the previous splitting ratio.

9. The method according to claim 1, further comprising:
calculating another splitting ratio for data of the plurality of data and that is other than the first target data when the available capacity of the first storage apparatus is smaller than or equal to a reference value;
splitting the data other than the first target data into a fifth piece of data and an sixth piece of data in accordance with the other splitting ratio;
storing the fifth piece of data in the first storage apparatus; and
storing the sixth piece of data in the second storage apparatus.

10. The method according to claim 1, wherein
the access states include an access frequency based on the numbers of updates of the plurality of data and the numbers of references to the pieces of data in a reference period of time.

11. The method according to claim 1, wherein
a speed of access to the first storage apparatus is higher than a speed of access to the second storage apparatus.

12. A system comprising:
a memory; and
a processor coupled to the memory and configured to:
obtain access states of a plurality of data when accessing to a first target data of the plurality of data is executed, respective data of the plurality of data being split into a certain data and other data, the certain data being stored in a first storage apparatus and the other data being stored in a second storage apparatus,
calculate a splitting ratio for the first target data based on the access states and an available capacity of the first storage apparatus,
split the first target data into a first piece of data and a second piece of data in accordance with the calculated splitting ratio,
store the first piece of data in the first storage apparatus, and
store the second piece of data in the second storage apparatus.

13. The system according to claim 12, wherein the processor is configured to:
calculate the splitting ratio for the first target data, based on a second available capacity obtained by subtracting a capacity used, in response to another accessing made subsequent to the accessing, for data other than the first target data from a first available capacity of the first storage apparatus.

14. The system according to claim 13, wherein the processor is configured to:
calculate the second available capacity based on the access states and sizes of the respective data of the plurality of data.

15. The system according to claim 14, wherein
the access states include access frequencies for the respective data of the plurality of data in a reference period of time, and
the processor is configured to:
calculate the second available capacity, based on a capacity of the first storage apparatus which is to be used when a first data of the plurality of data and whose access frequency is higher than or equal to the access frequency for the first target data is split based on a first splitting ratio, which is an upper-limit value of a rate for storage in the first storage apparatus, and a second data of the plurality of data and that is other than the first data is split based on a second splitting ratio, which is a lower-limit value of the ratio for storage in the first storage apparatus.

16. The system according to claim 12, wherein the accessing is access for updating the data.

17. The system according to claim 12, wherein
the accessing is access for referring to the data, and
the processor is configured to:
obtain the number of references to a second target data of the plurality of data when accessing for referring to the second target data is executed,
calculate the splitting ratio for the second data when the number of references reaches a reference number of times,
split the second target data into a third piece of data and a fourth piece of data in accordance with the calculated splitting ratio,
store the third piece of data in the first storage apparatus, and
store the fourth piece of data in the second storage apparatus.

18. The system according to claim 12, wherein the processor is configured to:
calculate the splitting ratio that is higher than or equal to a set second splitting ratio, which is a lower-limit value of a ratio for storage in the first storage apparatus, and that is lower than or equal to a set first splitting ratio, which is an upper-limit value of the ratio for storage in the first storage apparatus.

19. The system according to claim 12, wherein the processor is configured to:
obtain, when the accessing and previous accessing are the same in the first target data, the access state and a size regarding the first target data, and the available capacity of the first storage apparatus, a previous splitting ratio calculated for the previous accessing, and
split the first target data in accordance with the previous splitting ratio.

20. The system according to claim 12, wherein the processor is configured to:
calculate another splitting ratio for data of the plurality of data and that is other than the first target data when the available capacity of the first storage apparatus is smaller than or equal to a reference value,
split the data other than the first target data into a fifth piece of data and an sixth piece of data in accordance with the other splitting ratio,
store the fifth piece of data in the first storage apparatus, and
store the sixth piece of data in the second storage apparatus.
